(19) United States
(12) Patent Application Publication
(10) Pub. No.: US 2015/0104131 A1
(43) Pub. Date: Apr. 16, 2015

(54) SHUNT FIBER

(71) Applicant: OFS Fitel, LLC, Norcross, GA (US)

(72) Inventors: John Michael Fini, Metuchen, NJ (US); Linli Meng, Belle Mead, NJ (US); Eric Monberg, Princeton, NJ (US); Jeffrey W Nicholson, Warren, NJ (US); Robert Windeler, Annandale, NJ (US)

(21) Appl. No.: 14/391,902

(22) PCT Filed: Apr. 4, 2013
(86) PCT No.: PCT/US13/35345

§ 371 Date: Oct. 10, 2014

Related U.S. Application Data
(60) Provisional application No. 61/620,216, filed on Apr. 4, 2012.

(51) Int. Cl. G02B 6/26; G02B 6/032; G02B 6/02

(52) U.S. Cl. CPC G02B 6/268; G02B 6/02047; G02B 6/032
USPC 385/29

(57) ABSTRACT

Shunt fibers having a photonic bandgap cladding region including one or more hollow guiding regions of which one guiding region is configured as the core and one or more other guiding regions are configured as shunts, respectively, provide nearly single mode transmission in the core. The effective mode index of unwanted core modes and modes in one or more shunts are matched closely enough such that higher order modes will selectively couple to the shunt modes by resonant phase matching in the presence of fiber variations. The shunts are designed to have relatively higher losses thereby effectively dissipating power in the higher order modes at a faster rate.

### CROSS REFERENCE TO RELATED APPLICATIONS

This application claims priority benefit from the Provisional Application No. 61/620,216, filed on Apr. 4, 2012, in the United States Patent and Trademark Office.

### STATEMENT REGARDING FEDERALLY SPONSORED RESEARCH AND DEVELOPMENT

This invention was made with government support in part under a contract No. HR011-08-C-0019 granted by the Defense Advanced Research Projects Agency (DARPA). The government has certain rights in the invention. The views expressed are those of the inventors and do not reflect the official policy or position of the Department of Defense or the U.S. Government.

### BACKGROUND OF THE INVENTION

1. Field of the Invention

This application is related to the field of optical fiber and in particular, to large core-size Hollow Core Fiber (HCF) having Higher Order mode (HOM) suppression characteristics.

2. Description of the Related Arts

For several decades, commercial development of optical fibers has focused on silica, the best known solid material for guiding light. The breakthrough of using bandgap-guidance to trap light in a low-index core makes possible for use of the only better medium: a hollow guiding region. Hollow Core Fiber (HCF) offers enormous potential for light guidance without incurring significant loss in transmission. For telecommunications and sensing applications (including gyros), this suggests an ideal waveguide, free of the interactions that would inject noise and dissipate signals, provided interactions at the core surface can be made negligible. Hollow core guidance offers additional game-changing benefits in specific applications: For example, in delivery of high-energy laser pulses, HCF may operate beyond the peak-power limits where solid fibers are damaged. In low-latency communication applications, the purpose of the link is to guarantee the shortest-delay path available. Propagation in air or vacuum is the only way to be certain that the shortest possible delay is being approached, since air represents a speed-of-light delay significantly smaller than silica.

HCFs offer unique advantages for a number of applications, including the ability to guide optical signals in a medium with very low optical nonlinearity. For example, in optical communications links, and in sensors, nonlinearity causes significant signal impairment. Thus, use of a HCF has the potential to improve performance significantly in these systems. In order to fully realize this potential, an HCF would need to achieve sufficient low-loss for the relevant application. For some applications, it is also important to avoid impairments that arise when light is guided in unwanted modes, for example multi-path interference (MPI) and loss associated with mode-coupling. In particular, many applications require effectively single-mode operation or near single mode operation.

In known HCF, there is a tradeoff between loss and single mode operation. One source of loss is scattering from surface roughness at air-glass interfaces. While fabrication methods can impact surface roughness, they cannot reduce it below a thermodynamic limit. Some attribute this ultimate limit to surface roughness due to frozen-in capillary waves. The lowest loss in currently available HCF is already at or near this limit. Although desired, further reduction of loss has proven difficult to attain by further straightforward improvements in fabrication alone.

One way to further reduce the loss is to increase the core size and, thus, decrease the interaction of light with the surface. However, as the core size increases, the fiber tends to become multi-moded, and many of the higher order modes may have an associated loss that is comparable to that of the fundamental mode. For example, in a 19-cell or even in some 7-cell HCF, some higher order modes may persist during transmission of the fundamental mode and, thus, may contribute to signal impairment due to interference.

Whether a fiber can be operated effectively as a single mode fiber can depend on the particular system requirements. However, modal properties suggest that unwanted modes can pose severe challenges. Similarly, in proposed few-moded fibers having a few low-loss signal modes, there are other unavoidable persistent modes that could be a significant source of impairments (MPI, mode-coupling loss, etc). U.S. Pat. No. 7,356,233 issued on Apr. 8, 2008, to Fini, describes a hollow core fiber having a cladding area around a hollow core, the fiber designed to have a resonant coupling feature for mitigating losses from unwanted modes. Contents of this patent are incorporated by reference in its entirety.

More specifically, the HCF described therein includes a central core surrounded by an inner cladding region made from a uniform periodic lattice of holes. The resonant coupling feature in this design is an additional core having a smaller diameter placed within the inner cladding region, but somewhat away from the central core. The additional core, also referred to as a ‘shunt’ core, may be placed anywhere within the inner cladding region, preferably near the outer cladding. The addition of this shunt core provides a disruption, or a perturbation, in the periodicity of the inner cladding material, thereby generating cladding modes. By properly designing and constructing these perturbation regions, higher order modes of the central core may be resonantly coupled to the cladding modes. As a result, higher order modes are selectively dissipated rapidly due to high loss cladding modes. While this prior art approach is shown to be effective in suppressing some higher order modes, it can be improved upon by the following:
Improving sensitivity to fabrication: HCF structures are intrinsically sensitive to small geometric perturbations, and are difficult to fabricate to a precise design;
Suppressing multiple modes: while suppression of a single unwanted mode or mode group (e.g. LP_{1,1}-like modes) may be desirable, other modes may cause significant impairment; and
Designs that guide multiple low-loss signal modes.

In overcoming these shortcomings, one must also consider perturbations that particularly affect resonant coupling of optical modes introduced by bending the fiber.

### SUMMARY OF THE INVENTION

Embodiments of the present invention describe an optical fiber comprising a photonic band gap cladding region including an array of lattice holes, where the cladding region has a first hollow guiding region, configured as a core to support a signal mode and at least one unwanted mode, a second hollow guiding region configured to support at least one mode as shunt mode, wherein the effective index difference between the unwanted mode and the shunt mode is smaller than the effective index difference between the signal mode and any of the shunt modes, such that selective coupling of the unwanted mode to the shunt mode is preferred over coupling of the signal mode to any of the shunt modes. A further aspect of such embodiments includes variation along the fiber length of the effective index difference between the unwanted mode and the shunt mode, such that coupling between these modes occurs at some portions of the fiber but does not occur in other portions. These different coupling locations reflect the unwanted mode and shunt mode having substantially the same effective index at some positions, but substantially different effective indices at other positions along the fiber length. Despite any fiber variations, substantial index-mismatch exists between the signal mode and any shunt mode at substantially all positions along the fiber, such that any coupling of the signal mode over the total length of fiber is negligible.

In a different embodiment, a shift in effective index mismatch due to external effects, for example, a bend or a twist in the fiber, may be utilized to expand or tailor the range of effective index over which an unwanted mode and a shunt mode overlap. In one aspect of the invention, a bend induced shift in effective index mismatch may be treated as an additive perturbation to the effective index to facilitate resonant coupling between an unwanted mode and a shunt mode. Advantageously, a tailored effective index range can compensate for a nominal effective index mismatch arising from statistical variations in core and shunt geometries and other fiber parameters. The tailored effective index range can also facilitate coupling of more than one unwanted mode to the same shunt mode.

In one aspect of the invention, additive perturbations may arise due to known physical forms of the fiber which include, but are not limited to, packaging, cabling, twisting, spooling or laying the fiber out in a semi-helical geometry that may introduce a perturbation dependent on a varying fiber orientation. The orientation properties of the perturbation may be included in a statistical model to determine resonant phase matching conditions for an unwanted mode. The additive perturbation may be determined from external parameters, such as a bend diameter.

In one embodiment of the invention, one or more of lattice spacing of the inner cladding layer, core and shunt sizes, as well as shape, separation and dilation in core size may be selected to generate a nominal effective index mismatch between an unwanted mode and a shunt mode that may be compensated by an external perturbation. This perturbation may be a known amount of bend induced effective index shift. The nominal effective index difference and effective index shift may substantially cancel to facilitate coupling at some positions along the fiber. “Nominal” effective index mismatch means the effective index mismatch excluding variations. This may include the effective index mismatch where perturbations are neglected, and where variations are averaged over the fiber length.

In one embodiment of the invention, the fundamental mode of the fiber is a signal mode, and selective coupling of the unwanted mode enables the -fiber to effectively function or operate as a single mode fiber (SMF). In this embodiment, a HCF functions as a Perturbed Resonance for Improved Single Modedness (PRISM) fiber that would remove the light in the unwanted modes by coupling to one or more shunt modes designed to have higher loss.

For efficient mode suppression, it is not necessary that resonant phase matching occur at all points along the length of the fiber. In one aspect of the invention, resonant phase matching over a portion of the length of the fiber that is sufficient to suppress the unwanted mode or modes effectively. Advantageously, resonant phase matching may occur despite presence of surface modes arising at the boundary of the core and inner cladding. Accordingly, limits on design and manufacturing may be relaxed without compromising the mode suppression mechanism according to this invention.

One aspect of the invention allows designing a HCF that would function as a single mode fiber using a combination of statistical modeling combined with a step index fiber model. In particular, combining the two different modeling approaches allows for a very precise determination of design parameters such that effective index mismatching is made small enough to be compensated with a bend induced shift in the effective index mismatch that would not require unrealistic conditions on packaging and other physical layout constraints so as to render the fiber in-operational.

In one embodiment of the invention, one or more additional shunts may be included. The shunts may all be substantially similar, or may be dissimilar between one another. Similar shunts may act to increase the rate of coupling. Dissimilar shunts may act to improve the robustness of coupling, increase the range of effective index over which unwanted modes are coupled, or couple multiple unwanted modes. Shunts may be placed symmetrically or non-symmetrically with respect to the core or the cladding.

### BRIEF DESCRIPTION OF THE DRAWINGS

Different aspects of HCF design and construction according to the principles of the invention will be described in conjunction with drawing figures in which:

FIG. 1 shows prior art Hollow Core Fiber geometries—a) having a single central core, and b) having central core and shunts;

FIG. 2 shows a near ideal fiber having a core and one or more shunts, a) physical structure, b) effective mode index, and c) mode loss, respectively;

FIG. 3 shows a) effective index, and b) mode loss, respectively for a fiber having a core and one or more shunts;

FIG. 4 shows effective refractive index as a function of wavelength for a core signal mode and unwanted core modes, specifically a) shunt modes at a pre-determined location along the length of the fiber, and b) shunt modes accumulated along the length of the fiber;

FIG. 5 shows intermittent resonant coupling of modes corresponding to bends (a) in a spooled fiber, and (b) in a fiber in a helical arrangement;

FIG. 6 shows a) the geometrical structure of an embodiment of a 37-cell core fiber, and effective index profiles b) and c) for two different perturbations resulting from bends;

FIG. 7 shows a) the geometrical structure of an embodiment of a 19-cell fiber having a core and two shunts, and b) effective index profile including perturbation;

FIG. 8 shows a) an image of a fiber having a core and two shunts constructed according to the simulation shown in FIG. 7, and b) mode loss;

FIG. 9 shows mode characteristics of the fiber of FIG. 8, specifically a) relative power levels of higher order modes, b) mode image of higher order modes in a straight fiber, c) mode image of resonant coupling of higher order mode to shunt modes in a fiber with a bend, and d) residual higher order modes in a fiber with a bend;

FIG. 10 compares mode characteristics of a conventional hollow core fiber and a shunt fiber a) relative power levels of higher order modes, b) beam profile for a conventional HCF, and c) beam profile for a shunt fiber;

FIG. 11 shows performance of a fiber having a core and one or more shunts functioning as a single mode fiber;

FIG. 12 shows (a) an image of a fiber having a core and two shunts and (b) corresponding measured losses for light propagating in the core;

FIG. 13 shows higher order mode images of the fiber shown in FIG. 12a, a) straight section, and bent sections having a coil diameter of b) 15 cm, c) 8.9 cm and d) 4.5 cm, respectively;

FIG. 14 shows estimated mode suppression as a function of wavelength for the fiber shown in FIG. 12a;

FIG. 15 shows mode images of a prior art 19-cell core HCF coiled in, a) 15 cm diameter and b) 5 cm diameter, respectively;

FIG. 16 shows HOM content estimated from mode images shown as inset for PRISM fiber and prior art HCF;

FIG. 17 shows HOM content of exemplary PRISM fiber as a function of fiber length;

FIG. 18 shows effective index simulation results using a prior art step index fiber model;

FIG. 19 shows effective index calculations for different core shapes??; and

FIG. 20 shows a) geometry of 37-cell core with and without dilation, b) effective index calculations for a dilated 37-cell core with 19-cell shunts and c) effective index calculations for a dilated 37-cell core with non-identical shunts including both 19-cell and 10-cell shunts.

### DETAILED DESCRIPTION OF THE INVENTION

Different aspects of the invention are represented in different embodiments. Although each drawing figure shows one or more distinct features of the invention to facilitate clarity and ease of description, different aspects shown in other embodiments are not precluded. Different aspects of the invention may be combined to achieve different fiber properties desired for different applications. The invention may be practiced by applying the concepts presented within the broad framework and described using few representative embodiments, in many combinations and sub-combinations that may occur to those skilled in the art.

In this invention, comprehensive designs for constructing silica hollow core fiber (HCF) including one or more shunt s are presented. The principles outlined in this invention result in HCF with unwanted higher order modes (HOM) significantly suppressed from resonant coupling between them and modes of one or more of the shunts. The shunts are designed to have high losses and are strategically placed to dissipate HOM rapidly. Higher order core modes are suppressed in a broader range of effective mode index values due to variations in effective mode index along the fiber length.

Furthermore, such variations provide robustness to fabrication imperfections, since small unintentional shifts in coupling resonances can be cancelled by the variations. The variations enable suppression of many unwanted modes, since a single shunt mode can couple to multiple unwanted higher order modes at different points along the fiber. The strategy adopted here is more suitable for HCF having a large number of unwanted higher order modes. Advantageously, new HCF does not require special manufacturing equipment and may be manufactured using present day standard manufacturing process.

Length variations including bend perturbations are important for many different fiber types. The basic physical phenomenon has been considered previously with respect to designs of non-hollow-core fibers, for example in a non-patent literature publication by Fini entitled, “Pre-compensated resonant higher-order mode suppression in coiled large mode area amplifier fibers” published as a conference paper No. CMB6 in a 2008 Technical Digest of CLEO/QLES by OSA, the contents of which are incorporated by reference in their entirety.

Bend-induced coupling in a HCF was discussed by Meng et al. in a non-patent literature publication entitled, “Bend Tunable Coupling in dual hollow core photonic bandgap fiber”, published in OFC/NFOEC Technical Digest 2012, by OSA (paper No. OTh1H4, herein referred to as the “Meng” paper), the contents of which are incorporated by reference in their entirety. In this paper, only a single mode of each core was considered, and so selective coupling of different transverse modes was not discussed.

### Phase Matching in Inventive Hollow Core Fiber (HCF):

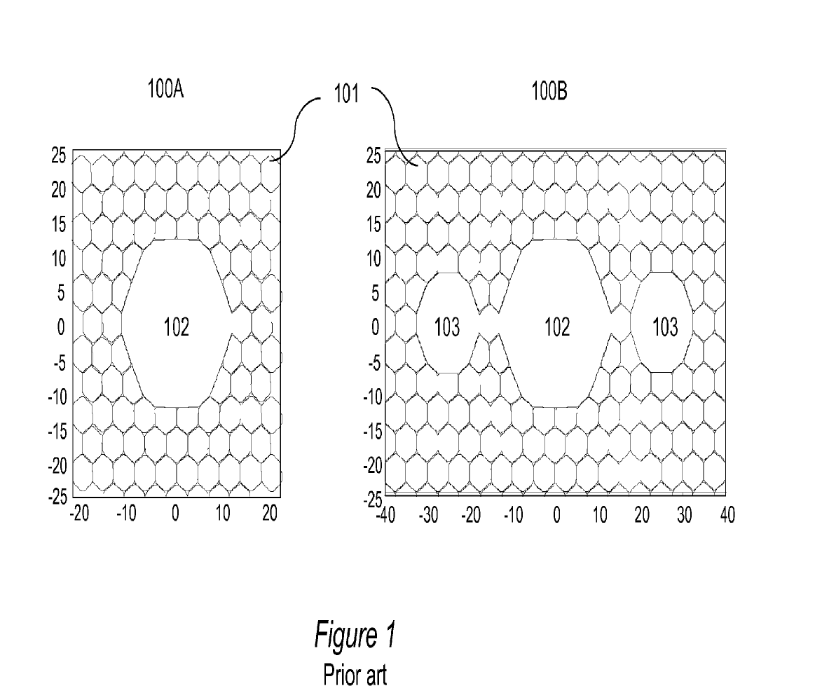

FIG. 1 shows a schematic view of known HCFs. More specifically, 100A in FIG. 1 represents a simple HCF comprising a photonic band gap material 101 including an array of lattice cells (also referred as lattice holes). The lattice cell region forms the inner cladding region. Typically, an outer cladding region surrounds this region. For simplicity, it is not shown in this picture. It is customary to describe a hollow guiding region or a core 102 as a region where a predetermined number of cells are omitted from the stack. The “size” of the hollow core is determined by the number of cells omitted for example, a “19-cell core,” means that the area of this core will be approximately 19 times the area of a lattice cell (lattice hole) of the array.

It is also understood that the area of a hollow core region, such as region 102, can be significantly altered, for example, by changing draw conditions, controlling pressures in the guiding and the size of the lattice hole regions, etc. Thus the size of a guiding region is a combination of its “topological size” (e.g., 19-cells) and “dilations.” Both the topology, and stretching, can be used to define the size and shape of a hollow guiding region in order to achieve an effective index required to obtain a desirable phase matching condition for guiding optical signal modes through the hollow core. For example, preferred guiding regions or cores, are nearly circular or elliptical in shape and all the modes are guided within a circular region. The circle can be centered on a hollow core (e.g., standard 7-cell and 19-cell) on a vertex, or on a web. Elliptical arrangements (e.g. Meng, OFC 2012) are also suitable, and can be described by the number of cells in each row, for example the 13 cell fiber of Meng has a “4-5-4” shape (5 cells in the central row with 4 cells above and below).

FIG. 1 also shows a HCF 100B comprising an inner cladding region including a photonic band gap material 101 described earlier. This configuration, besides having a central core 102 in the inner cladding region, has one or more additional hollow guiding regions 103 (only two shown in this example) located adjacent to the central core. The additional guiding region in this example will be referred as a ‘shunt’ and the fiber having a shunt will be referred as ‘shunt fiber’, respectively, for the purpose of discussion hereinafter. It is noted that a shunt is also a hollow guiding region therefore the fiber designed according to this invention has multiple ‘cores,’ where the term ‘core’ could also be broadly applied to a shunt.

However, for the purpose of discussion, a hollow guiding region that only guides a signal mode will be referred as a “core”, whereas other hollow core region(s) that do not guide a signal mode will be referred as “shunt(s).” For the purpose of discussion, any mode guiding useful or desirable signals will be referred as a “signal mode”. All other core modes will be referred as ‘unwanted’ or ‘impairment’ modes, irrespective of the type or origin of the impairment. For example, impairment or unwanted modes may be surface modes arising due to surface irregularities at the core boundary or higher order modes in a large diameter core, etc. The shunt is designed such that the effective index of a shunt mode is substantially lower than the mode index of a signal mode. As a result, a shunt does not support modes that can resonantly couple to a signal mode.

A key concept for selectively coupling unwanted modes is the coupling of one or more unwanted modes to one or more shunt modes should be much larger than coupling of any of the signal modes to one or more shunt modes. In addition, a shunt may be designed to have higher loss such that any unwanted modes coupled to the shunt would decay at a faster rate. Furthermore, position of a shunt relative to the core and outer cladding (not shown in FIG. 1) may be selected such that an unwanted mode coupled to a shunt decays rapidly by coupling to one or more outer cladding modes. Additional structural features that would provide high loss paths, such as surface roughness at the shunt boundary, impurities, etc. may be provided for rapid decay of selectively coupled impairment or unwanted modes. Accordingly, shunt design in HCF is a key feature of this invention for selectively coupling unwanted optical modes from the core to one or more shunts, thereby facilitating the HCF to function primarily like a single mode fiber (effectively or nearly single-moded).

Coupling is generally defined as a combination of coupling strength and phase matching; differential coupling could be accomplished by manipulating the field profiles (giving differential coupling strength), but is accomplished primarily through differences in phase matching in most of the examples to be described shortly. Accordingly, unwanted modes to be suppressed are better phase-matched one or more shunt modes as compared to any of the signal modes to the shunt modes. Precise phase matching of unwanted modes with very high selectivity using one or more shunt modes is a key principle of this invention for separating signal mode(s) that carry useful information. Furthermore, an important aspect of this design lies in the fact that better phase matching of any particular unwanted core mode to a shunt mode may be achieved when the effective mode index difference or effective index mismatch between the participating modes is small. This key concept will be demonstrated shortly by exemplary fiber designs.

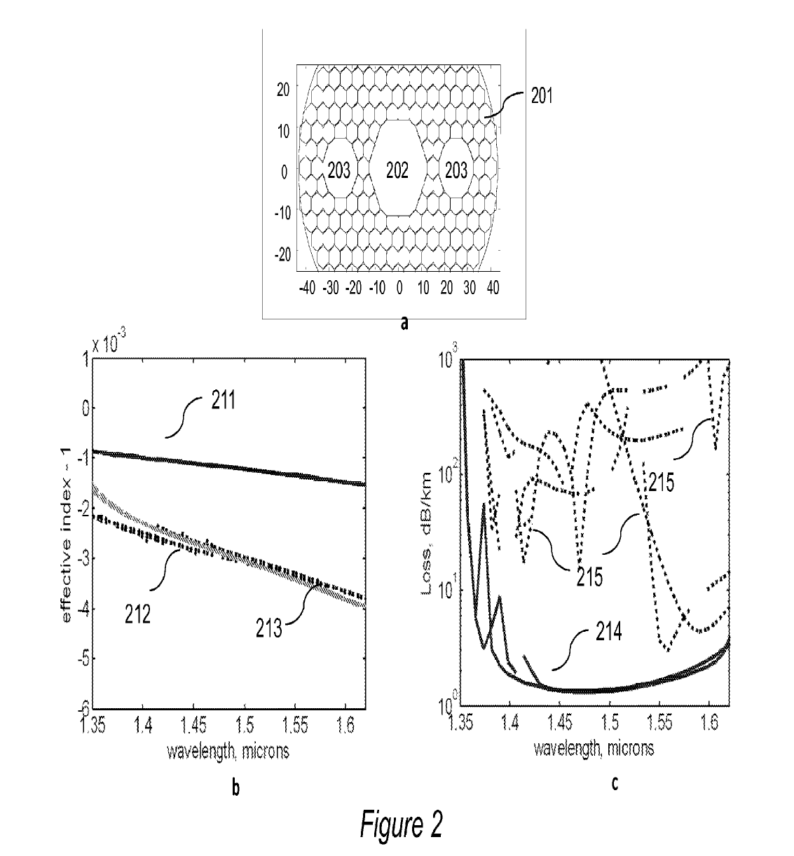

Key concepts of unwanted mode suppression through selective coupling to the shunt mode(s) may be explained in reference with an exemplary HCF shown in FIG. 2. More specifically, FIG. 2a shows the schematic geometrical structure of a fiber comprising a 19-cell core (202) with two 7-cell shunts (203) located in a photonic band gap cladding material 201 including an array of lattice cells. For illustrative purposes, fiber geometry is assumed to be fairly idealized with the shunts placed symmetrically on two sides of the core. The core width along the horizontal direction (with respect to the drawing figure in this example) is 5 lattice periods and the core-web thickness is 0.5 times the thickness of a lattice web. It is further assumed that lattice hole spacing Λ=5 μm, and the lattice air-fill fraction as 95%. While this geometry is selected for ease of discussion, there are other geometries that may be selected for designs that are especially suited for certain applications. Those considerations will be described later.

In FIG. 2b, effective mode indices of different core and shunt modes are plotted as a function of wavelength (in μm). In particular, trace 211 (solid) represents the fundamental core mode having a mode index higher than that of the other modes. The unwanted core modes shown as 212 are LP_{1,1}-like modes of the center core (dotted), and have substantially the same effective mode index as the fundamental modes of the shunts shown as 213 (dashed trace), thereby generating near precise phase-matched resonant condition for coupling LP_{1,1} like modes to the shunts modes. At the same time, the effective mode index of shunt is too small to support any guided modes at the effective mode index of the fundamental (trace 211). As a result, phase matched coupling of the fundamental core mode to the shunt modes is not supported.

While hollow-core modes are not precisely identical to standard “linear polarization” modes used in fiber theory, a particular HCF mode will often be clearly associated with a an LP_{N,M} mode, in the sense that the LP mode profile is similar and has high overlap integrals with the HCF mode. Thus, the phrase “LP11-like” mode is used if it resembles the LP₁₁ mode. Similarly, a HCF mode may be associated with a group of LP modes if a superposition of those modes has similar mode profile to the HCF.

The calculated excess loss introduced by the shunts is found to be negligible. Other unwanted modes, including the LP_{2,1}-like core modes and surface modes are present in the bandgap (not shown), but a broad region is present from wavelength, λ, =1430 nm to 1610 nm where the fundamental mode loss is free of surface mode features. FIG. 2c shows mode loss for different core modes. More specifically, mode loss is plotted (y-axis) as a function of wavelength (x-axis). Over this wavelength range (λ˜1430 nm-1530 nm), loss in the fundamental mode shown as trace 214 is substantially lower than the loss in unwanted modes shown collectively as 215 (LP_{1,1} like modes in this example) and also much lower than loss of surface modes. The results of this calculation indicate that the mode supported in the core is predominantly the fundamental mode because the unwanted modes selectively couple to the shunt. In fact, the shunt may additionally be designed to have high loss such that the unwanted modes leak out rapidly.

In a well-designed near ideal HCF, the selective resonant coupling of unwanted modes to the shunt is quite precise, such that the fundamental core mode is practically guided as a single mode, allowing for the HCF to effectively operate or function as a single mode fiber. In reality, this is difficult to achieve without putting very stringent conditions on the manufacturing process of such a fiber. The phase matching condition is not only sensitive to the intrinsic characteristics of the HCF, but also is extremely sensitive to fabrication irregularities and, in particular, to the surface modes arising due to the detailed geometry of the core walls. Small imperfections, exacerbated by the fabrication complexity can ruin the ideal condition for selective coupling of unwanted modes. In addition, it may cause usual high-loss wavelength regions associated with surface-mode crossings.

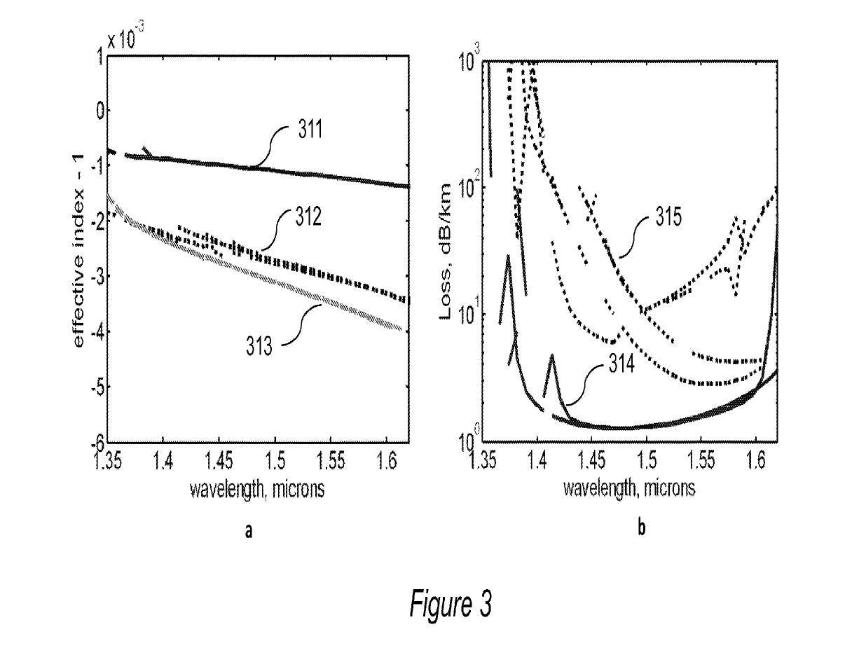

In fact, in the highly idealized example described in reference with FIG. 2, conditions to achieve good phase matching (leading to the suppression of the unwanted modes) are quite sensitive. Even for small deviations from phase-matching conditions, difficulty in suppressing unwanted modes, such as, for example, the LP_{1,1} modes, for longer wavelengths λ>1550 nm or at the surface mode crossing around λ=1470 nm is quite apparent. Sensitivity to selective phase matching is further illustrated in FIG. 3. More specifically, FIG. 3a shows the effective mode index (y-axis) as a function of frequency (x-axis) for HCF with a similar geometrical structure to the one shown in FIG. 2a, but having approximate 5% larger core size. More specifically, the fundamental mode 311 still has a significantly higher effective mode index as compared to the higher order LP_{1,1} like mode 312. Moreover, the effective index of the LP_{1,1} mode matches better with the shunt mode 313 in this case as well. And while a slight change in the core size leads to only a small mismatch in effective mode indices between the unwanted mode(s) 312 and the shunt mode(s) 313 as shown in FIG. 3a, it causes an almost complete degradation of the calculated coupling. Mode loss plotted as a function of frequency for the unwanted LP_{1,1}-like modes 315 (dotted lines) shown in FIG. 3b, are now only a few times larger than the loss shown for the fundamental mode (314) as compared to traces 215 and 214 shown in FIG. 2b, an indication of persistent and problematic core modes. This example illustrates that unless fabrication of a design is nearly perfect, single-mode operation may be difficult to achieve in practice.

HCF parameters that play important roles in selective suppression of unwanted modes, according to the present invention, are:
Core size—core size influences many aspects including fabrication difficulty, birefringence, surface mode density, and bandwidth. Core size is selected to provide a low loss optical path for signal modes and appropriate phase matching conditions for selective coupling between unwanted core modes and shunt modes;
Shunt size—proper selection of sizing of one or more shunts facilitates selective phase-matching between shunt modes and unwanted core modes. Multiple shunt sizes may provide complimentary phase-matching conditions;
Core-web and shunt-web geometry—provides desirable surface mode features according to principles well known in the art;
Spacing between core and shunt—arrangement of shunt(s) relative to the core and spacing between them is selected to control loss of signal modes and strength of coupling and/or total amount of suppression of unwanted modes;
Cladding size, hole spacing, hole shape, and air-fill fraction—are selected to provide strong confinement of signal modes, thereby reducing signal loss according to principles well known in the art, and may be designed to provide tunneling loss of the shunt modes as well;
Variations along the Length—variations in fiber properties along the length of the fiber provide phase matching condition for selective coupling of unwanted core modes to shunt modes. Variations may be unintentional or may be intentionally designed that may or may not be intrinsic to the fiber. These variations may be controlled through fabrication, cabling or other arrangement of the fiber for example, a bend, twist, etc., as well as by properties of the fiber itself, such as mechanical stiffness and outer cladding diameter; and
Additional features—for example, absorptive materials or surface roughness near shunts if additional shunt loss is needed over simple tunneling loss, asymmetric features to provide birefringence in the core and/or shunt or other features that provide desirable properties for selective coupling of unwanted modes to the shunt modes.

### Phase Matching in Non-Idealized Hollow Core Fiber (HCF):

While the simulation results shown in FIGS. 3a and 3b indicate that the selective phase matching condition is extremely sensitive to the structure of the core and shunt, the design is more robust than it appears. It is known that small, unintentional variations in fiber properties would result in a variation in effective mode index, thereby causing a shift in the resonant coupling condition along the length of the fiber. As a result, conditions for resonant coupling and, therefore, selective suppression may not be uniform throughout the length of the fiber. If resonant coupling exists in different sections of the fiber, this may be sufficient to suppress some or all of the unwanted modes.

One important aspect of this invention is that although phase matched coupling is difficult to predict and control due to the limitations of manufacturing process, variations in the fiber along its length can make the phase matched coupling more robust than predicted from an idealized structure described in reference with FIGS. 2 and 3. In practice, an unwanted mode would couple to a shunt mode even if the effective mode index of the unwanted mode matches with the shunt mode only in certain parts of the fiber along the fiber. Thus, unwanted core modes are suppressed statistically in a broader range of effective index values due to variations in effective index arising from variation in physical properties of the fiber around respective nominal values. The statistical nature of the selective phase matching process is particularly suitable for a fiber having a few signal modes, and a large number of unwanted modes. Furthermore, many different unwanted core modes may be phase matched to the same shunt mode at different points along the fiber. Advantageously, this particular aspect is extremely beneficial in mitigating the effects of limitations in fiber manufacturing process.

Variations in fiber properties give rise to variation in effective index values because any type of variation in fiber properties can function as a perturbation in the periodic properties of the HCF structure, and in particular, the photonic band gap properties. As a result, the mode effective index of various modes is altered to different degrees, depending upon the magnitude or the degree of perturbation. The variations may be intrinsic to the fiber fabrication process, or extrinsic, intentionally controlled or random or unintentional, or even combination thereof. These variations may include, but are not limited to, structural changes intrinsic to the fiber fabrication process. For example, variation in the core and/or shunt dimensions, surface roughness, relative placement of core and shunt, etc. As the shunt size is an “intrinsic” property of the fiber structure, the size of the shunt or other hole sizes may intentionally be varied during the fiber draw process. At the same time, fiber fabrication methods may be adjusted to impart random variability in the fiber cross-section (thus, intrinsic), or, alternately, the inner surface of the shunts could be roughened or contaminated, resulting in random variations in shunt modes.

Variations may be envisioned as different types of perturbations that alter the phase matching conditions either in a controlled or a random fashion. It can be appreciated that such variations may be used to tune the phase matching conditions to selectively couple certain or all unwanted modes to shunt modes rather than coupling unwanted modes only to the cladding modes. For example, bending the fiber introduces bend induced perturbations that may drift randomly as a function of orientation of the fiber. On the other hand, the perturbation may be controlled (by cabling or fiber arrangement), but the variation is not controlled, since what is actually varying is the orientation (which is not controlled). In yet another situation, the fiber may be bent or twisted in a definite winding pattern to control the perturbation in a periodically varying fashion. Notably, the structure of the fiber (core size, shunt size) does not change over the nominal values, therefore, these types of variation are extrinsic to the structure of the fiber, itself. Advantageously, a specific variation may be added controllably to prevent random drift in effective phase matching condition.

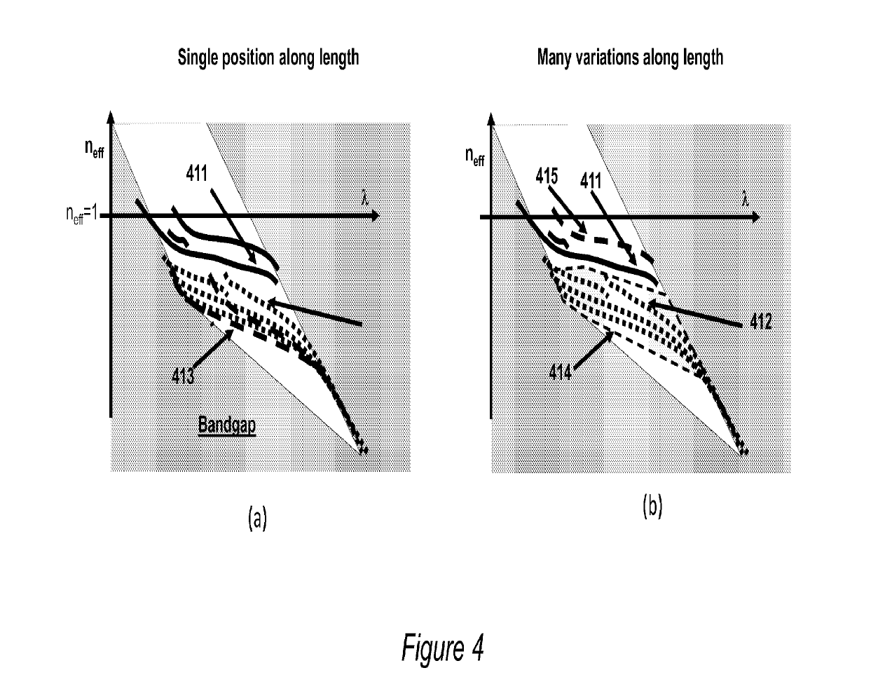

In one aspect of the invention, appropriate design parameters for one or more shunts are selected to preferably induce a phase matching of unwanted modes (HOM) to shunt modes. This is illustrated in FIGS. 4a and 4b, where the effective index, n_{eff}, of different modes is plotted as a function of wavelength λ. More specifically, in FIG. 4a, effective mode index values for signal modes 411 (solid), unwanted modes 412 (dotted), and shunt modes 413 (dashed), are plotted as a function of wavelength at an arbitrary position along the length of the fiber. The modes are permissible in a region shown in white, whereas the shaded area represents the photonic band gap region. It is clearly shown in FIG. 4a that at a given position along the length of the fiber, a shunt mode 413 may not be sufficiently index-matched with an unwanted mode 412 to achieve the desired selective suppression.

However, taking into account variations in fiber properties along the length of the fiber, such as variations in core and shunt(s) properties, a different picture of effective index matching is achieved as shown in FIG. 4b. Due to the variations in the fiber properties, the effective index values of the shunt modes are not just one or two modes as shown by distinct dashed lines 413 in FIG. 4a, but are randomly distributed over a shaded region 414 bounded by the dashed lines (FIG. 4b). Thus, when variations along the length are included in the model, the phase-matching condition for coupling an unwanted mode to one or more shunt modes falls within a broad range of effective refractive index. As a result, effective suppression of unwanted modes may still be achieved despite a change in core or shunt properties that are within reasonable fabrication limitations often encountered in the fiber fabrication process.

It should be noted that taking variations into account, unwanted modes in a fiber with variations along the length of the fiber would achieve phase-matched coupling much more robustly than would be possible in a fiber with no variations. Although it may be desirable to suppress all unwanted modes, this may not be absolutely essential for transmitting a signal in the core effectively in a single mode. Significant benefit may still be achieved by suppressing only some of the unwanted modes. For example, it may be sufficient to suppress modes that tend to have low loss, that are prone to be unintentionally launched (e.g. LP_{0,2}-like modes), higher order modes that tend to couple to the fundamental (e.g. LP_{1,1}-like modes), or those shown to cause excessive impairments.

To model the phase matching condition statistically in the presence of variations in effective index, the phase matching condition is alternatively expressed in terms of a mismatch between the effective index of signal or unwanted modes and shunt modes collectively. For example, to selectively suppress an unwanted mode, minimum mismatch in the effective index between a signal mode and a shunt mode has to be greater than a minimum mismatch in effective index between an unwanted mode and a shunt mode. Using this concept, variations in effective index may be modeled as a variation in mismatch in effective index. An index mismatch may vary along the length of the fiber for the reasons noted earlier. An alternative way to model and treat these index mismatch variations is to use a statistical measure for effective index mismatch averaged over all variations (irrespective of their origin). Other statistical measures, such as a weighted average, a 10-percentile value, etc. may be defined for generating design guidelines for designing and configuring different types of HCF. Another suitable metric for the effective index mismatch may also be derived for example, from a coupled-mode model.

### Phase Mismatch Due to External Perturbation:

In the Meng 2012 paper, it is demonstrated that phase mismatch may also be caused due to a bend or a twist along the length of the fiber that may naturally occur due to spooling or deployment, for example. Under common fiber deployment conditions, bend induced shift in phase mismatch may be predominantly unintentional, or otherwise difficult to precisely control. However, the bend induced shift in phase mismatch is well understood and may be modeled in terms of a bend diameter and corresponding index mismatch, and is incorporated as a perturbation in the simulation model described earlier.

Advantageously, by spooling or wrapping the fiber in a prescribed manner for example, using a pre-determined bend diameter, a required amount of bend induced perturbation may be introduced to expand the range of effective index matching of the unwanted modes and the shunt modes, or may be used to compensate for the phase mismatch arising due to variation in intrinsic properties of the fiber. Another advantage of bend induced perturbation is that a pre-determined amount of perturbation can be applied in a reasonably precise manner after the fiber is fabricated and tested thereby allowing additional flexibility in suppressing unwanted modes in HCF.

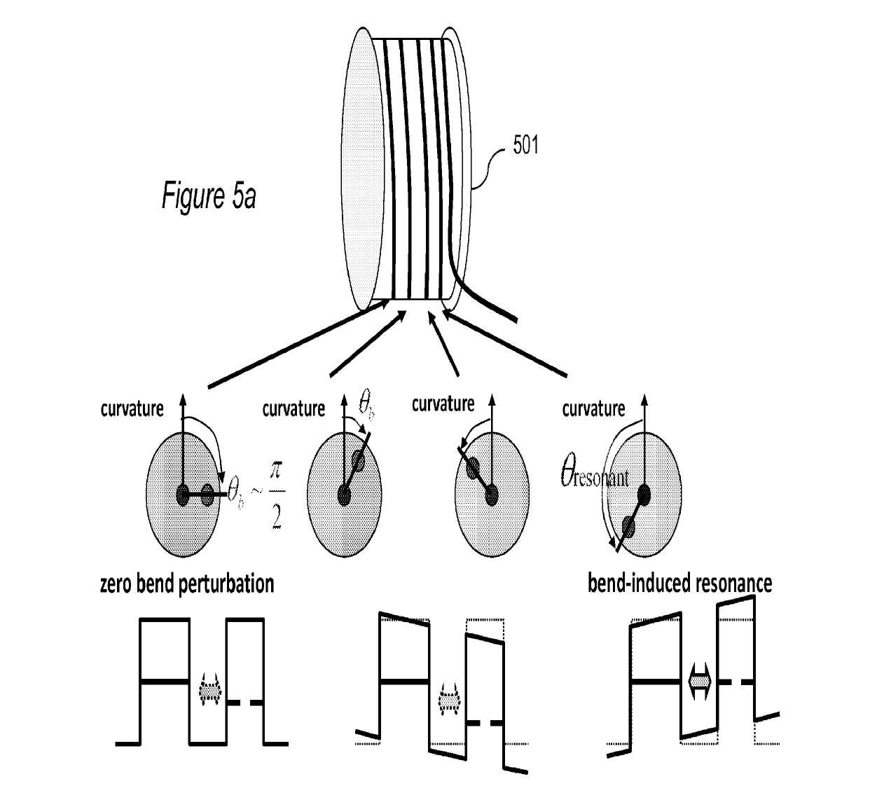

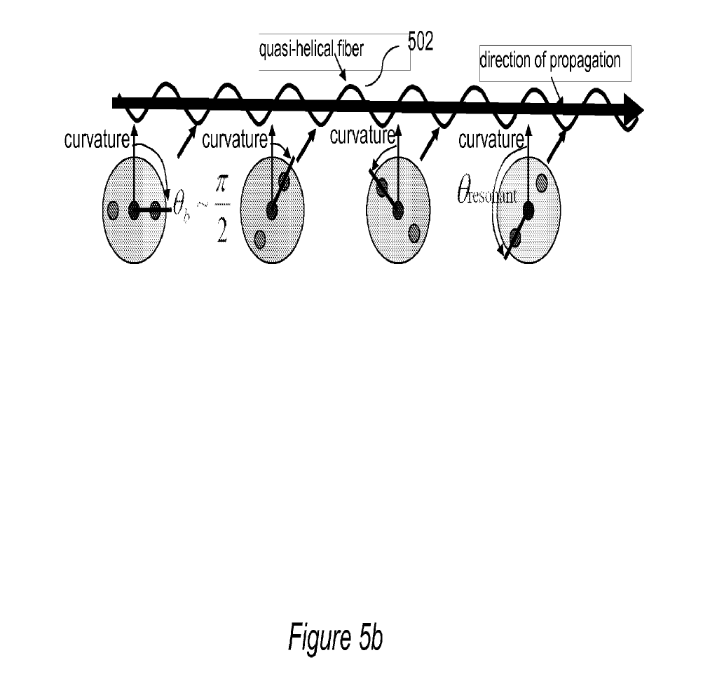

FIG. 5 illustrates intermittent phase-matching resonances that occur where the bend induced perturbation cancels the unperturbed index mismatch. Bend perturbations may arise in a spooled fiber, for example, spooled fiber 501 shown in FIG. 5a. Perturbations may also arise due to an approximately helical arrangement 502 of a fiber as shown in FIG. 5b. The lower plots in FIG. 5a show the bent-fiber equivalent index profile and mode effective index for the two cores (solid and dashed horizontal lines). In most fiber arrangements, bend orientation will vary along the fiber length, either randomly or due to systematic spin or twist. As bend orientation drifts, the bend perturbation contributing to mismatch oscillates. If the bend is tight enough, each pair of cores sees index matched resonance twice for each 2π of orientation drift.

Bend related perturbation may be modeled quite accurately in terms of a bend radius and other parameters of a HCF. In one aspect of the invention, a bend induced perturbation Δnₚₑᵣₜ resulting from a known amount of bend or a twist in the fiber is used as a means to provide a predetermined amount of compensation for index mismatch between the core and shunt modes. The perturbation Δnₚₑᵣₜ is introduced as a length-varying additive quantity to the index mismatch. More specifically, a bend with curvature 1/R_{b} (where R_{b} is the bend radius) is introduced to add equivalent relative index perturbation Δnₚₑᵣₜ=nₛₕᵤₙₜ aₛₑₚ cos(θ_{b})/R_{b}, where nₛₕᵤₙₜ is the refractive index of the shunt (nₛₕᵤₙₜ=1 if the hollow shunt contains a vacuum), aₛₑₚ is the separation of the core and shunt, θ_{b} is the orientation of the bend with respect to the fiber and cos(θ_{b}) is the orientation of the shunt-core separation with respect to the bend. If the fiber orientation with respect to the bend varies sufficiently, then, at various positions along the fiber, each shunt mode sees perturbations in the full range-aₛₑₚ/R_{b}<Δnₚₑᵣₜ<aₛₑₚ/R_{b}. Similarly, other perturbations (shunt size variation, materials on the shunt surface, etc) can induce a length-varying Δnₚₑᵣₜ, achieving intermittent coupling with or without a bend. An advantage is the perturbation associated with a particular bend radius may be calculated in advance and the fiber may be deployed to achieve that bend radius with reasonable accuracy.

Another aspect of this invention is to design a HCF where effective index mismatch between an unwanted core mode and a shunt mode is minimized to facilitate resonant coupling. Principles for determining the effective index of modes of the core and shunt of HCF are well known in the art. Using these principles, different combinations of core and shunt sizes that tend to suppress unwanted modes of the core while not simultaneously suppressing signal modes (or ensuring that any suppression of the signal mode is negligible) are determined. It is important to note that unlike previous HCF designs, variations in effective index mismatch and bend (twist) related mismatch are included in this model such that selective phase matching between the unwanted core modes and one or more shunt modes is achieved in a wider range of effective index in a reproducible manner.

Phase-matched coupling between core and shunt is determined primarily by core size and shape, shunt size and shape, the number of cores and shunts, distance between the core and shunt(s) (or relative positions), as well as the distance of the shunt from the cladding outer boundary or an outer cladding of the fiber. Taking into account the variations in effective index mismatch resulting in a spread in shunt and surface modes in a wavelength region of interest, careful selection of these parameters will ensure that the mismatch between the effective mode index of a core signal mode and a shunt mode is significantly higher than the mismatch between effective mode index of a unwanted core mode and a shunt mode. In the following section, specific simulation examples in accordance with design principles of this invention are presented to illustrate different strategies that may be employed in designing the inventive HCF.

### Example A

### 37-Cell Core and 7-Cell Shunts

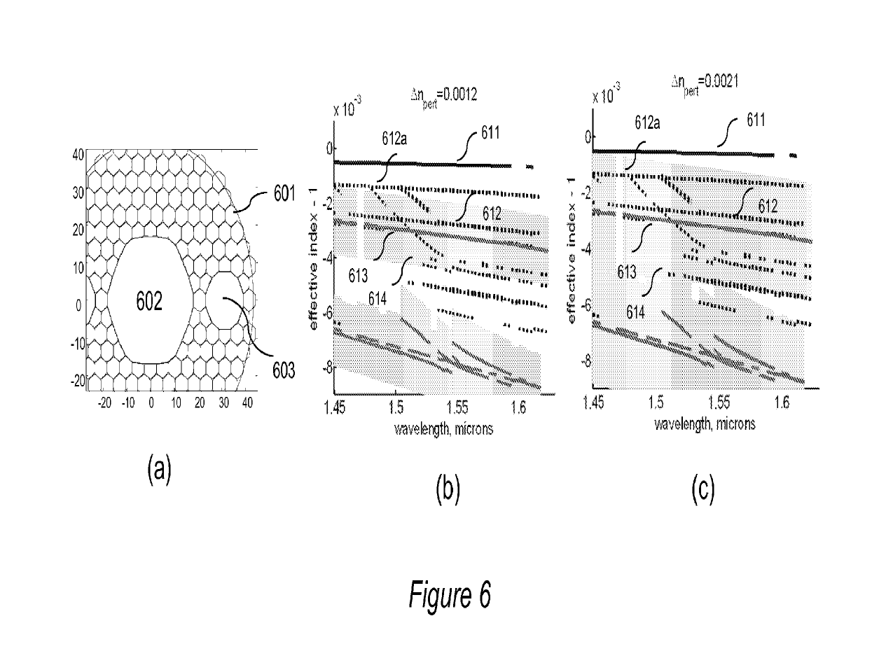

In an exemplary embodiment shown in FIG. 6, a 37-cell core, and 7-cell shunt fiber geometry is selected. More specifically, the fiber geometry shown in FIG. 6a comprises an array of lattice cells or lattice holes 601 with a lattice hole spacing of about 5.2 μm, providing a bandgap and low-loss guiding around 1550 nm. An air-fill-fraction in the lattice hole is about 95.5%. A central core region 602 is created by removing 37 lattice cells in the center in a “4-5-6-7-6-5-4” arrangement (37-cells core) and each of two shunts 603 (only one shown for clarity) has a 7-cell shape (7-cell shunt). The core-web thicknesses are adjusted to obtain a relatively surface-mode-free region in the calculation.

Results of effective index as a function of wavelength from simulation with a small amount of perturbations are plotted in the graphs shown in FIGS. 6b and 6c, respectively. In the effective index plots shown in FIGS. 6b and 6c, the fundamental modes 611 are signal modes. The other low-loss modes 612 represent unwanted modes that may be potentially problematic modes. The graphs also show shunt modes 613. Surface modes are identified by the simulation as well, but are not shown.

In FIG. 6b, there is a wide region around 1550 nm where the signal mode 611 sees no surface mode crossings, but there are several potentially problematic unwanted modes 612. With a small variation in index mismatch in the form of a perturbation, Δnₚₑᵣₜ=0.0012 (for example, equivalent to a 5 cm bend diameter), some of the unwanted modes 612 fall within Δnₚₑᵣₜ of a shunt mode shown as shaded region 614, and, thus, experience intermittent resonant coupling. Some unwanted modes, notably the LP_{1,1}-like modes shown as 612a fall outside of the shaded region, and will experience little or no resonant coupling. Thus, this simulation suggests that the small perturbation Δnₚₑᵣₜ=0.0012 is not sufficient for achieving single-moded operation for this particular exemplary fiber as the unwanted core mode(s) are not coupling to the shunt mode(s). In contrast, FIG. 6c indicates that if a relatively large perturbation Δnₚₑᵣₜ=0.0021 is introduced (for example, equivalent to a 3 cm bend diameter) nearly all of the red modes fall within Δnₚₑᵣₜ of a shunt mode again shown as shaded region 614, and, thus, will experience intermittent resonant coupling.

FIG. 6(a)-(c) illustrates the interplay of fiber design, index mismatch variation, and system-level requirements. For example, a fiber so designed may be suitable for single-mode operation where Δnₚₑᵣₜ=0.0021 is enforced by cabling, variation in shunt size by pressurization, etc. In some cases it may be desirable to provide suppression under “typical” and “worst-case” arrangements. For example, if the LP_{1,1}-like modes are particularly problematic, and if the “worst case” arrangement of the fiber (e.g., fiber stripped of cabling or uncoiled) in a system involves low perturbation, then the absence of suppression of LP_{1,1} for smaller perturbations may be a significant disadvantage of this design, even if the “typical” arrangement (e.g. fiber cabled or coiled) provides adequate suppression.

However, the same exemplary fiber would be more suitable in an application where a few modes are launched in a spatially-multiplexed operation. For example, when LP_{0,1}-like and LP_{1,1}-like modes are all signal modes, and where variations are maintained around a bend induced perturbation of Δnₚₑᵣₜ=0.0012. In this case, as shown in FIG. 6b, the signal modes 611 and some modes in the group of 612 are not phase matched, such as mode 612a, but many other unwanted modes are suppressed by intermittent phase-matching. In fact, for this application, larger perturbations would likely result in significant loss of a signal mode, and system impairment.

For a given fiber design, the ideal level of variation involves a tradeoff: large variations typically provide more robust suppression of unwanted modes, but variations that are too large will result in an excess loss of the signal modes. The right balance can be identified by calculations, as in this exemplary simulation, and/or by measurements on fibers constructed according to the design rules, etc. What is important to note is the bend induced perturbation or other variations may be used advantageously in compensating for effective index mismatch arising due to structural imperfections that may naturally occur while constructing the fiber. The desired level of perturbations must be consistent with other well-known constraints (e.g., tight bends can cause fiber breaks; unintentional bends may be introduced in deployment; perturbations will be introduced by temperature, strain, contamination, etc).

### Example B

### 19-Cell Core and 7-Cell Shunts

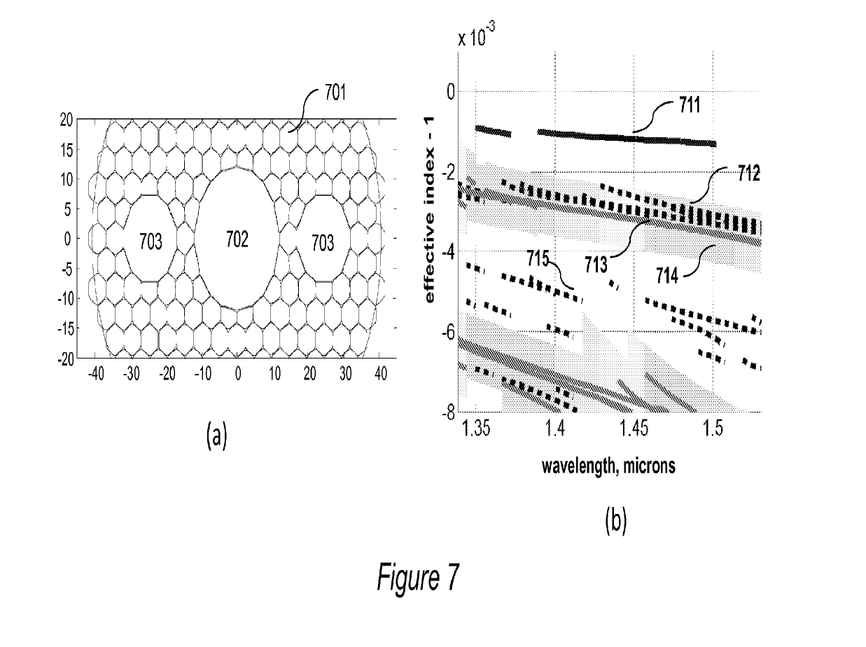

Shown in FIG. 7 are simulation results for an inventivefiber. The fiber geometry shown in FIG. 7a comprises an array of lattice cells or lattice holes 701 including a 19-cell core 702 and two 7-cell shunts 703 located symmetrically on either side of the core. The calculation assumes an idealized core and shunt geometry with a lattice hole spacing of about 4.9 μm, and an air-fill fraction of 95.5%. The simulation takes into account slight distortions from ideal circular shape for the core that may result in some surface modes. The simulation model also accounts for an index mismatch variation equivalent to a perturbation Δnₚₑᵣₜ=0.0007, that would result from a 7 cm bend diameter. As shown in FIG. 7b, shaded regions 714 (only one labeled) show perturbed shunt mode effective indices, and each shaded region surround a solid line 713 indicating the corresponding unperturbed shunt mode effective index.

The core and shunt sizes are selected such that a fundamental mode 713 of each shunt with an unperturbed mode index is located quite close to the LP_{1,1}-like modes 712 of the core (upper dotted curves), as shown in the graph in FIG. 7b. Thus, the LP_{1,1}-like modes are effectively phase matched within the uppermost shaded region 714. If the orientation of the bend with respect to the fiber (θ_{b}) was not controlled, and thus θ_{b} drifted though all angles, modes anywhere in the shaded region would be index-matched at some point in the fiber, allowing for all four LP_{1,1}-like modes (collectively 712) of the core, along with any other unwanted modes, can be suppressed by resonant coupling to the shunt.

The fundamental core modes 711 are far from the phase-matched region, and experience no excess loss for a reasonable range of variations. The size of the 7-cell shunts provides for phase matching between the shunt fundamental mode 713 and the core LP_{1,1} modes 712 even for smaller variations, and so this design would exhibit moderate HOM suppression in a variety of bend conditions, including those that might arise in a cabled fiber. The unwanted core LP_{1,1} mode 712 is much closer to index matching the shunt modes 713. However, dotted curves exist outside of the shaded regions, representing the LP_{2,1}-like modes, (shown as 715) and thus have an index mismatch much larger than |Δn_{bend}|, and do not experience resonant suppression.

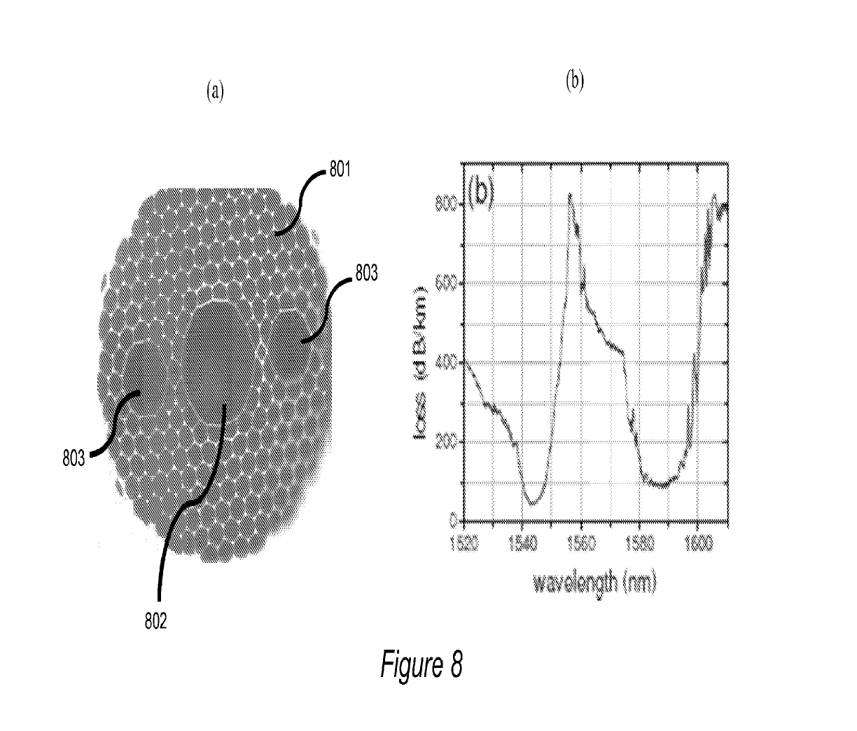

Simulation results described in reference to FIGS. 7a and 7b are used to design and construct a HCF fiber using a modified stack-and-draw process. The stack-and draw process of constructing HCF is well known in the art and that description will not be repeated. Geometric structure of the fiber constructed according to this invention is shown in FIG. 8a. In FIG. 8a, a microscope image of a fiber cross section including a cladding region 801 comprising a photonic band gap material having an array of lattice holes. The cladding 801 includes a 19-cell core 802 having a diameter of 24.6 μm, and two 7-cell shunts 803, each having diameter 7.7 μm. Lattice hole spacing is about 4.9 μm (all dimensions nominal) and the air-fill fraction is approximately 95%. The loss over a 100m segment of this fiber is plotted as a function of wavelength in a graph shown in FIG. 8b; the loss was measured to be about 44 dB/km at 1543 nm.

Relative power levels and mode beat images of higher order modes of the exemplary fiber in FIG. 8a are characterized by S² method by spatially resolving the spectral interference pattern caused by modes propagating with different relative group delays. The S² method is well documented in the art and will not be described again. A 3 m length of hollow core fiber was fusion spliced to a single mode pigtail fiber (SMF) using a short, cold splice. The 3 m length of fiber was laid out in a very large loop, as well as coiled into loops, each 7 cm in diameter. The input and output ends of the fiber were held fixed so that the only change in the mode content was from the coiling. A narrow linewidth tunable laser tuned with a wavelength step size of 0.001 nm is used to illuminate the fiber. The output end is cleaved and imaged onto a CCD camera and at each wavelength, a beam profile is acquired with a Indium Gallium Arsenide (InGaAs) infra-red camera. A three dimensional set of data corresponding to an optical spectrum for each pixel of the camera is obtained. The optical spectrum of each pixel then was Fourier transformed to obtain a plot of the beat between the higher order mode and the fundamental mode as a function of the relative group delay of the higher order mode.

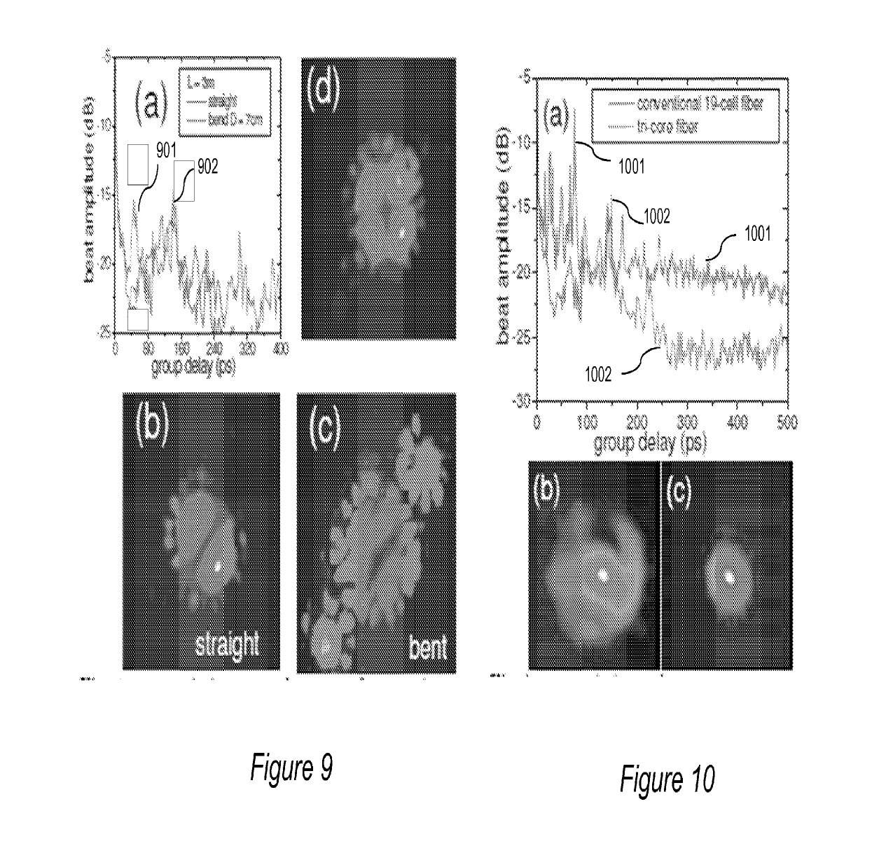

FIGS. 9a-d show results from measuring the mode content of the exemplary fiber of FIG. 8a. In particular, the graph of FIG. 9a shows represents discrete mode scattering as a function of group delay. The two traces (901 and 902, respectively) are for a straight fiber and for a fiber bent in 7 cm diameter, respectively. Strong peaks in the graph shown in FIG. 9a represent data corresponding to discrete scattering of modes at the splice point. For the straight fiber (trace 901) the peak at 50 ps corresponds to the LP_{1,1} mode and the peak at 150 ps group delay is an LP_{2,1} mode, respectively. When the fiber is placed in a 7 cm diameter coil (trace 902), the peak at 50 ps corresponding to LP_{1,1} is almost completely eliminated. Corresponding mode images of higher order modes are shown in FIGS. 9b-9d. More specifically, FIG. 9b shows the mode image when the fiber is laid straight. Strong presence of higher order mode is evident.

FIG. 9c shows that power from the 19-cell core is coupled to the 7-cell shunts located on either side of the core when the fiber is coiled to a diameter of 7 cm. FIG. 9d shows that a strong reduction in power in the higher order mode content is observed in the core region. Power remaining in the core (shown in FIG. 9d), includes significant LP_{2,1} mode content. It is quite evident that the coiling did not effectively suppress the LP_{2,1} mode. The failure to suppress the LP_{2,1} mode in a condition where the LP_{1,1} mode also is suppressed could be explained in view of FIG. 7b where the phase-matching result is shown for a similar fiber geometry. Referring back to FIG. 7b, there it shows that LP_{1,1} falls within the region of phase matched coupling, but the LP_{2,1} mode, shown as 715 in FIG. 7b, does not. The method of S² also provides information about power in higher order modes relative to the fundamental mode. Power measured in the LP_{1,1} mode is reduced by approximately 10 dB when the fiber is coiled to a diameter of 7 cm, as compared to when the fiber is held straight. Thus, the suppression of the LP_{1,1} by coiling the fiber is more than 3 dB/m.

FIG. 10 shows data obtained on a 3m length of a conventional 19 cell HCF with 2 dB/km loss at 1500 nm and that of the exemplary fiber of FIG. 8a using the S² measurement setup for comparison. More specifically, trace 1001 shows results obtained on the conventional fiber and the trace 1002 shows results obtained on the exemplary inventive fiber. The total integrated HOM content for the conventional fiber was estimated to be greater than −9 dB, whereas the total HOM content for the inventive fiber was estimated to be −17 dB. The strong HOM content severely distorts the output beam of the conventional fiber (FIG. 10b) but the HOM suppression in the exemplary fiber results in a substantially cleaner beam profile (FIG. 10c).

Failure to suppress some unwanted modes (e.g. LP_{0,2} and LP_{2,1} group) may be acceptable, if coupling to these modes is sufficiently small, or if such modes have sufficient loss. In the data shown in FIGS. 9 and 10, modal impurity is dominated by modes that fall in-between the phase-matching bands, as expected, but the total impurity in the exemplary fiber is quite small and may even constitute effective single-mode operation for some applications. Returning to the simulation shown in FIG. 7b, surface-modes cross through the LP_{2,1}-LP_{0,2} group at wavelengths around 1420-1470 nm, and cause elevated loss in these modes at some wavelengths. However, from FIG. 7b it is evident that in a space division multiplexed signal, LP_{0,2} and LP_{2,1}-like modes (shown as 715 in FIG. 7b) may be used as signal modes in addition to the LP_{0,1}-like modes, since these all fall outside of the phase-matching regions for shunt-mode coupling. In a space-division multiplexing application, signals in the two bands might experience little crosstalk since they are widely separated in index and all have even symmetry (so that micro-bend perturbations do not couple them).

### Near Single Mode Operation of a Fiber Having a Core and One or More Shunts:

Returning back to the embodiment described in reference with FIGS. 2a and 3, and in particular with the fiber shown in FIG. 2a, it was shown that the selective phase matching is extremely sensitive to the core size. Recalling that discussion, a small increase (˜5%) in the core size resulted in substantially lower selective coupling of unwanted modes and, in particular, to LP_{1,1} like modes. A logical conclusion was that unless fabrication of a design is nearly perfect, suppression of unwanted modes and therefore single-mode operation may be difficult to achieve in practice.

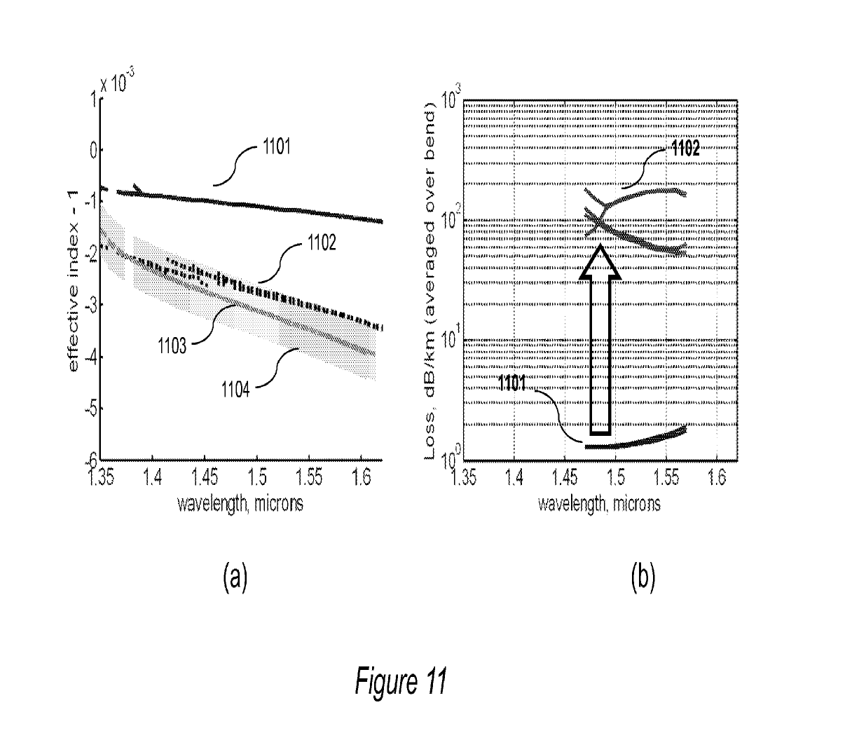

In one embodiment of the invention, the fiber described in the previous section is configured to function effectively as a single mode fiber. In this embodiment, referred to as a PRISM (Perturbed Resonance for Improved Single Modedness) fiber, the fiber described earlier separates undesirable light components with high selectivity. A basic principle of the PRISM fiber configuration is illustrated in FIG. 11. In this embodiment, the fiber described in reference with FIG. 2a is made more robust by including a small pre-determined amount of perturbation. FIG. 11a shows effective index with mode loss shown in FIG. 11b for the exemplary PRISM fiber designed according to the embodiment shown in FIG. 2a with a length varying perturbation equivalent of a 10 cm bend radius added to the effective index.

Calculations are made for fundamental and LP_{1,1} like modes that are expected to be the most problematic, respectively, in a selected wavelength range. The average mode loss is calculated and plotted for an even sampling of bend orientations in this illustrative example. In these calculations, a standard model of loss including tunneling and surface-scattering are considered. Additional processes, such as mode-coupling loss, are neglected, but are thought to significantly increase analogous losses near a surface-mode-crossing resonance. It should be noted that a standard loss model used here would greatly underestimate the degree of HOM suppression achieved in practice.

Calculated losses combine the tunneling loss with an estimate of surface scattering loss: Loss=Loss_{tunneling}+(C×F), where F is the standard surface overlap integral, and the constant C was held at 81, in reasonable agreement with recorded fiber loss measurements. The orientation-averaged loss in FIG. 11 was derived from 18 different mode calculations sampling 5-degree increments in orientation.

More specifically, the effective indices of a fundamental core mode shown as 1101 (top solid trace), of unwanted LP_{1,1} like core modes shown as 1102, and of a perturbed shunt mode shown as 1103 are plotted as a function of wavelength in FIG. 11a. It is quite clear that the effective index 1102 of the LP_{1,1} like mode does not quite match effective mode index 1103 of a shunt mode as would be expected from the discussion in reference with FIG. 3. However, a shift in effective mode index due to a perturbation introduced by a 10 cm diameter bend results in a spread in the effective mode index of the shunt mode shown as a shaded region 1104. Therefore, effective mode index of LP_{1,1}-like modes are matched with the effective mode index of the shunt mode somewhere along the length of the fiber. As a result, the LP_{1,1} like modes would be resonantly coupled to the shunt mode and would be suppressed as reflected in FIG. 11b where mode loss is plotted as a function of wavelength. Loss in the LP_{1,1} like modes, shown by trace 1102, is substantially higher than as compared to the loss in the fundamental mode, shown by trace 1101. Those skilled in the art will appreciate that the HCF thus constructed would effectively function as single mode fiber.

It can be recognized by those skilled in the art, that, according to this invention, it is not necessary that the fiber be perfectly designed, constructed, or rigorously characterized in order for mode suppression to be effective. It is also not necessary to suppress the surface modes completely. Fibers constructed with limited manufacturing tolerance would still result in a reasonably good single mode performance as long as the coupled modes have small enough resonance mismatch that it can be cancelled with a reasonable bend (e.g., without introducing significant bend loss of the fundamental or physically snapping the fiber). This invention provides a realistic methodology for designing and constructing HCF where, perhaps, quantitative modeling is generally not practical, fiber geometry cannot be adequately characterized over the entire length of fiber (may only be sampled at a few points along the length in a manufacturing environment), or major spectral features cannot be systematically controlled.

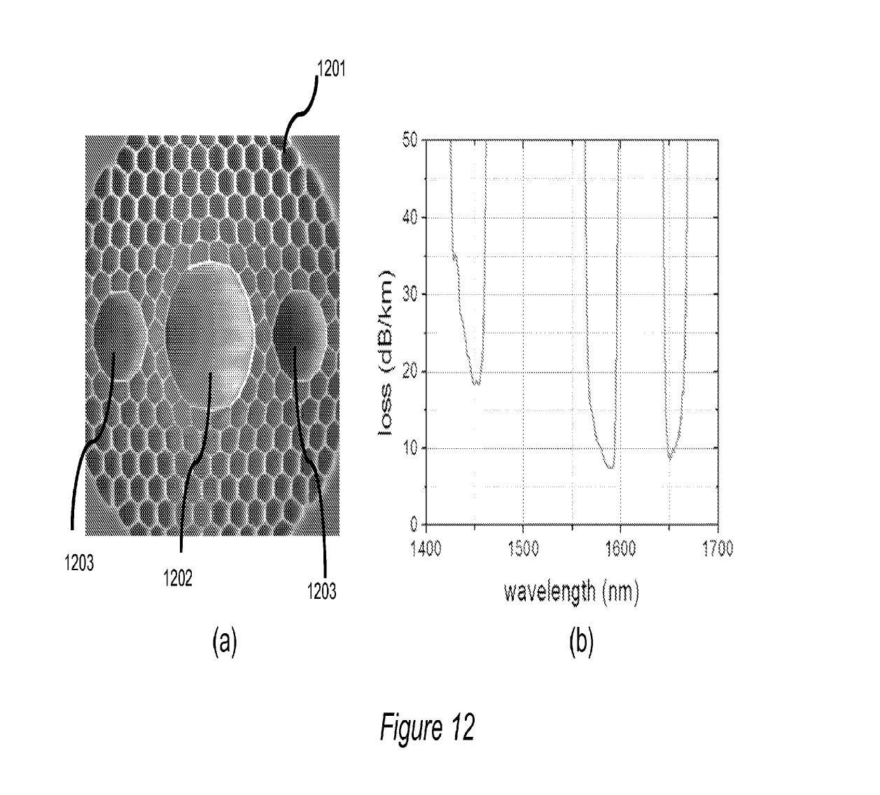

A nearly single mode PRISM fiber designed according to the principles described earlier having one core and two shunts is shown in FIG. 12a. More specifically, FIG. 12a shows a Scanning Electron Microscope (SEM) image of a cross section of the PRISM fiber. The fiber comprises an array of lattice holes 1201, having a spacing of about 4.5 μm between holes, and air fill fraction around 95%. The fiber includes respectively, a 19-cell core 1202 having a diameter of about 23.0 μm, and two, 7-cell shunts 1203, each having a diameter of about 13.6 μm. Loss measured on a 200m length of fiber by cutback method is shown in FIG. 12b. The minimum loss at 1590 nm was measured to be about 7.5±0.5 dB/km.

As one would expect for a complex geometry, the fiber shows visible geometric distortions (particularly in between the cores) and high-loss features in the bandgap (e.g. at wavelengths 1550 nm and 1600 nm). The imperfect geometry is thus responsible for narrow wavelength ranges over which low loss is achieved. Improvements in fabrication or design are expected to give lower losses over a wider bandwidth while still achieving the suppression of unwanted modes.

Mode properties of the exemplary PRISM fiber in FIG. 12a are characterized by measuring interference between coherent modes that propagate with different group delays in the fiber under test using a sliding window Fourier transform of high-resolution transmission spectra. The input and output of the hollow-core PRISM fiber were fusion spliced to a standard single-mode fiber (SMF). A narrow linewidth (few hundred kHz) tunable laser was launched into the fiber under test, and the transmission was measured with a power meter. The frequency of the laser then was tuned through the wavelength range of interest. A small subset of the transmission data was selected with a narrow window and Fourier-transformed. The window was then slid through the entire transmission spectrum to produce a two dimensional plot of the mode content as a function of both wavelength and differential group delay (DGD in picoseconds), also known as a spectrogram.

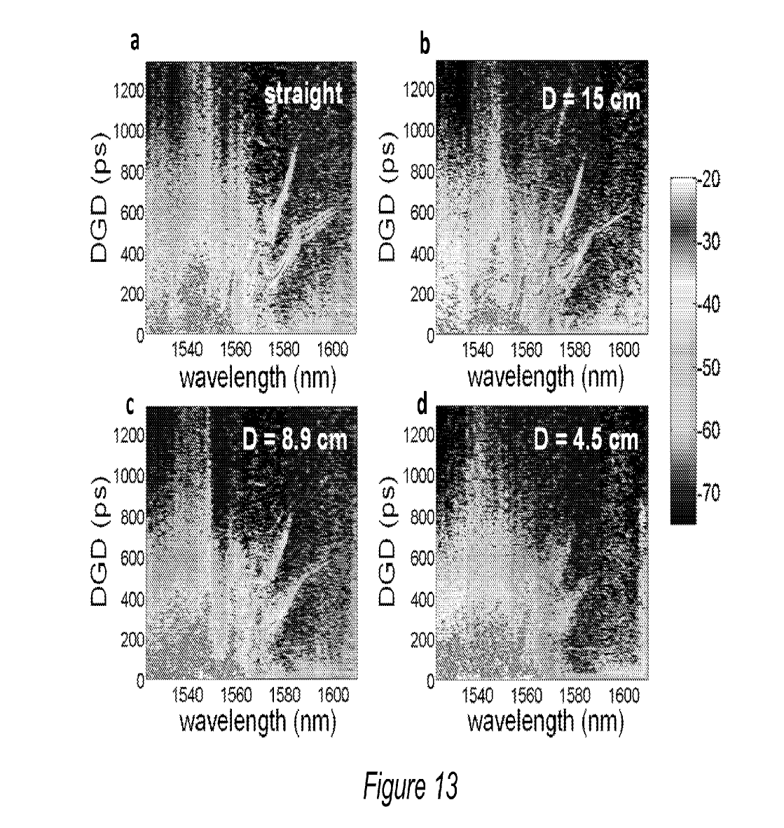

Measured spectrograms of the exemplary PRISM fiber are shown in FIGS. 13a-d. In particular, FIG. 13 gives a representation of the amount of mode content measured as a function of differential group delay (relative to the fundamental, plotted on y-axis) and as function of wavelength between 1520 nm and 1580 nm (on the x-axis, including the low loss transmission window around 1590 nm). The shading in the figures represents the mode power magnitude, and, in particular, bright “finger” like structures extending around 1590 nm are of particular interest. More specifically, in FIG. 13a, a mode spectrum for a straight piece of PRISM fiber is shown to have significant amount of HOM content. As the fiber is coiled, and further, coiled tightly, the HOM content tends to reduce progressively. As shown in FIGS. 13b, 13c, and 13d, HOM contents for coil diameter approximately equal to 15 cm, 8.9 cm and 4.5 cm, respectively. In fact, for a coil diameter of 4.5 cm, the HOM content is reduced significantly.

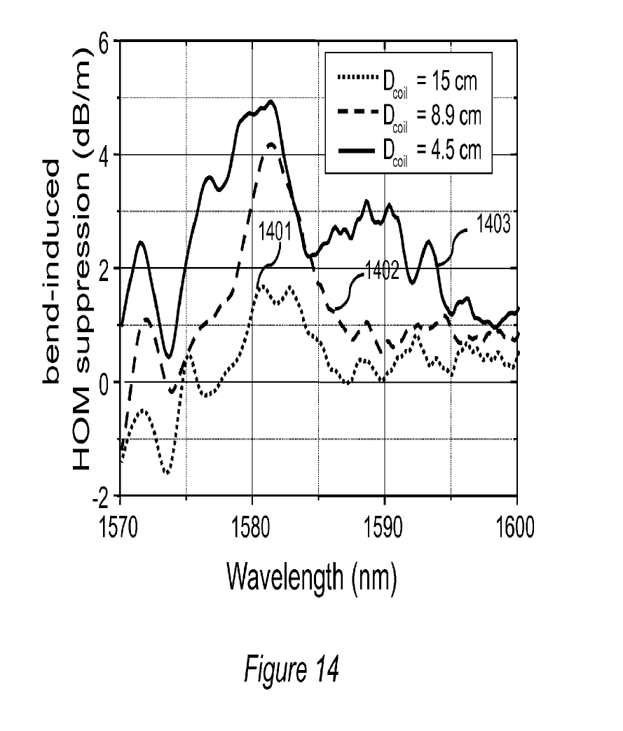

The spectrograms shown in FIGS. 13a-d are integrated along the differential group delay axis to provide an estimate of total HOM content as a function of wavelength. More specifically, when the HOM content of the straight fiber is subtracted and normalized to the fiber length, bend induced HOM suppression may be estimated. Results from this very calculation are plotted in FIG. 14. In particular, an estimated bend induced mode suppression in dB/m is plotted (on y-axis) as a function of wavelength (on x-axis). The dotted line 1401 represents HOM suppression corresponding to the largest coil diameter 15 cm, and the dashed and solid lines 1402 and 1403 represent HOM suppression corresponding to the tighter coil diameters of 8.9 cm and 4.5 cm, respectively. From this graph, it is evident that the fiber coiled tightly (thereby producing a smaller coil diameter) suppresses HOM significantly.

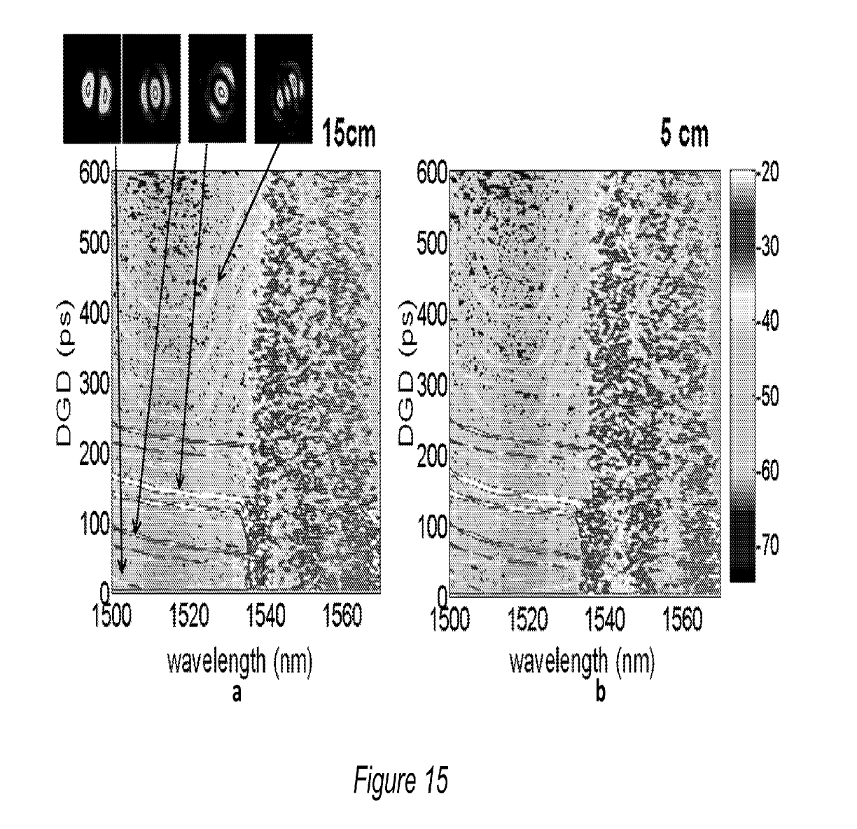

Results obtained for the PRISM fiber show substantial improvement in performance over a conventional 19-cell HCF. The conventional HCF selected for comparison has a loss of 5.2 dB/km at 1520 nm. A spectrogram for the conventional 19-cell hollow core fiber is shown in FIG. 15. In particular, mode spectra for the conventional fiber placed in two coils having coil diameters of 15 cm and 5 cm are shown in FIGS. 15a and 15b, respectively. In addition, modal contents corresponding to the HOMs in the low-loss region are imaged using the S² imaging technique described earlier. Mode content (similar to that shown in FIGS. 9b, 9c and 9d) corresponding to different HOMs is shown as the inset of FIG. 15a.

It is noted that, in the conventional HCF, the number of higher-order modes guided in the low-loss wavelength range from 1500 nm to 1530 nm, is substantially higher as compared to the PRISM fiber even when the PRISM fiber is placed straight (recall FIG. 13a). Furthermore, there is no observable change in the mode content when the coiling diameter is changed from 15 cm to 5 cm. This was expected as higher-order modes of a conventional 19-cell core HCF tend to be well-confined modes having calculated losses only a few times that of the fundamental mode (see FIG. 3b). It is known that typically, the fundamental modes of a conventional HCF are quite robust to bending or coiling of the fiber.

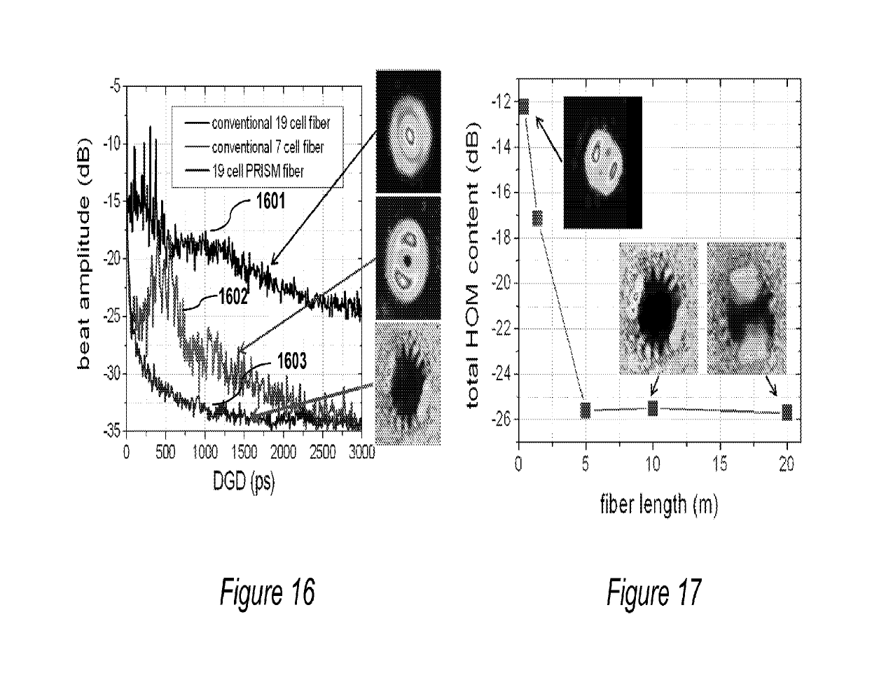

Performance of the exemplary PRISM fiber constructed as per this invention is further compared with a conventional 7-cell core HCF having a 16 dB/km loss and a conventional 19-cell core HCF having a loss of 5.6 dB/km, respectively, using the S² imaging method mentioned earlier. The PRISM fiber in this experiment was coiled to a diameter of about 8.9 cm. It is well known that the conventional 7-cell core HCF exhibits superior single mode operation, and the conventional 19-cell core HCF exhibits record low loss (˜1 dB/km). For this comparison, a 10 m length of each type of fiber was used. An analysis of measured data is plotted in a graph in FIG. 16 showing mode beat amplitude as a function of DGD (differential group delay) for three different fibers: the conventional 19-cell core HCF 1601 (upper trace), the conventional 7-cell core HCF 1602 (middle trace), and the inventive PRISM fiber 1603 (bottom trace).

By analyzing the data of the mode content over the entire range of group delays, the total HOM content and an image of the sum of HOMs is shown in the inset to the right of the plot in FIG. 16. More specifically, from the data obtained it is evident that the total HOM content (compared to the fundamental mode) is about −7.6 dB, −22 dB and −27 dB for the conventional 19-cell core HCF, the conventional 7-cell core HCF, and the inventive PRISM fiber, respectively. Further, the mode images shown at the inset in FIG. 16 reveal that HOMs in the conventional 19-cell core HCF and 7-cell core HCF primarily consist of unwanted core-guided modes (the LP_{0,2} and LP_{1,1} respectively), but in contrast, the unwanted core modes have been completely removed from the inventive PRISM fiber, leaving only residual surface modes. It can be appreciated that while the inventive PRISM fiber may have geometrical imperfections and surface modes, the performance of the PRISM surpasses the conventional 7-cell core HCF in loss as well as in single mode operation. Further calculations show that a well-designed 19-cell core inventive PRISM fiber would exhibit improved single mode operation.

In the prior discussion it has been disclosed that to suppress HOM in a fiber constructed according to this invention, it is not necessary for the effective mode index of a HOM to match the effective mode index of one or more shunt modes along the entire length of the fiber. That is, it is sufficient that effective mode index of LP_{1,1}-like modes have a reasonable chance to be matched with the effective mode index of the shunt mode somewhere along the length of the fiber. More precise mode-content measurements can be obtained by S² measurements. FIG. 17 shows an S² imaging cutback measurement on a 20 meter length of a PRISM fiber designed according to an embodiment of the present invention: that is, a series of S² measurements taken as the fiber length is cut back from 20 m. The fiber length is progressively cut back and characterized, to obtain changes in mode content as a function of length and plotted on the graph.

In FIG. 17, estimated HOM content is plotted as a function of fiber length. Mode images are shown as insets at respective lengths of the fiber indicated by arrows. It is evident that at a longer length of the fiber, the HOM and, in particular, unwanted core-guided modes (such as LP_{1,1}-like modes) are sufficiently suppressed. The modes that are left are mostly surface modes. As the fiber length is reduced to about 5 meter, there is no significant rise in the HOM contents. The HOM content rapidly increases for shorter fiber lengths.

From the above observations it is inferred that for very short lengths of fiber (0.4 m) there is substantial HOM content launched in the core. However, these modes rapidly decay within about 5 m of fiber length, and the only modes left are small amounts of surface modes. It can be well appreciated that fibers designed according to the principles of this invention are made robust by introducing a pre-determined amount of bend (in this case utilizing the random variation of bend), so that the bend-induced effective index shift compensates for the index mismatch arising from imperfect fiber physical characteristics, such as, for example, core and shunt diameters and other manufacturing defects, that can introduce surface modes etc.

### Design Guidelines Using a Statistical Model:

As has been mentioned in earlier discussions, due to variations in the core and shunt diameters and surface roughness along the core-cladding boundary, effective index matching condition between the unwanted core modes and shunt modes need not be met at all points along the length of the fiber. It is also clear that it is not physically possible to measure or characterize these properties very accurately throughout the length of the fiber. Despite these limitations, different examples described in the previous section demonstrated that the unwanted modes are effectively suppressed under different scenario according to the principles of the invention. One key aspect of this invention is that the effectiveness of suppression of unwanted modes need not require perfect design and/or construction of a shunt fiber. Instead, mode suppression can occur selectively despite imperfections in the fiber due to the fact that the selective mode suppression results from statistical effective index matching of unwanted core modes with one or more shunt modes over the entire length of the fiber. Using a statistical analysis it is possible to frame a set of design guidelines that would incorporate the fiber parameters as well as perturbations of one or more type into the statistical model. In the following section, some general principles of design will be described to achieve selective mode suppression effectively, including near single mode performance of HCF (in cases where there is only one signal mode).

General guidelines may be formed in terms of minimum effective index shift arising due to variations in fiber properties. The variations include, but are not limited to, core and shunt physical dimensions, stretching, surface roughness at the core inner cladding boundary, bends or twists in the fiber cabling, spooling, or laying, etc. The design strategies to be disclosed shortly are based on treating variations in a statistical fashion along the length of the fiber. More specifically, guiding of modes is treated in terms of effective index mismatch of signal and unwanted modes with the effective index of shunt modes, which is represented as:

[symbol]

$$\text{?} \vert \text{?} - \text{?} \vert \text{?} \vert \text{?} - \text{?} \vert \\ \text{?} \text{indicates text missing or illegible when filed} \qquad ( 1 )$$

where, the left hand term min_{j,variations} represents a minimum effective index mismatch (or simply, index mismatch) between the signal mode and any shunt mode taking into account ‘j’ shunts and all length variations, and the right hand expression min_{l,variations} represents a minimum index mismatch between the unwanted core modes and any shunt mode of the shunt, n_{eff} [symbol] is the effective mode index of signal mode, n_{eff} [symbol] is the effective mode index of ‘j’^{th} shunt, n_{eff} [symbol] is the effective mode index of an unwanted core mode (or an impairment mode that causes impairment in signal transmission), and n_{eff} [symbol] is the effective mode index of the l^{th} shunt, respectively.

In writing this expression, it is assumed that each of the two minimum index mismatches is the smallest index mismatch of any position along the length of the fiber. Since this expression says that signal modes should have greater index mismatch than suppressed modes, this expression applies for n_{eff} [symbol] of those unwanted modes that are suppressed by coupling to shunts, but other unwanted modes may not satisfy this requirement and may be managed by other means. Often, the core modes include several signal modes that are the highest-index guided modes, as well as unwanted modes including relatively low-index modes. The most problematic unwanted modes that require effective suppression are those having an index closer to the lowest index of the signal modes.

Designating the lowest index signal mode ‘S’ and highest index unwanted mode ‘U’, the minimum effective index difference

[symbol]

$$\vert \text{?} - \text{?} \vert$$

$$\text{?} \text{indicates text missing or illegible when filed}$$

between the two modes is referred to as mode spacing for the purpose of discussion. It should be noted that the minimum effective index mismatch of a mode may vary along the length of the fiber and may even be higher at some point than the other. However, if the condition for phase matching is satisfied anywhere along the length of the fiber, resonant phase matching is effectively achieved. The statistical nature of the process is the essence of this invention.

Using this general representation of index mismatch, broad strategies for achieving selective suppression of unwanted modes may be formulated. In one embodiment, the fiber is designed so that, of all the shunt mode effective index values, the closest to the signal mode effective index corresponds to the shunt mode j and variation where the shunt mode index approximately equals the index of the unwanted mode,

[symbol]

$$\text{?} . \\ \text{?} \text{indicates text missing or illegible when filed}$$

In this case, the minimum index mismatch between a signal mode and a shunt mode is approximately equal to the mode spacing between the lowest index signal mode (S) and the highest index unwanted mode (U). The condition for phase matching is expressed as—

[symbol]

$$\text{?} \vert \text{?} - \text{?} \vert \text{?} \vert \text{?} - \text{?} \vert \\ \text{?} \text{indicates text missing or illegible when filed} \qquad ( 2 )$$

The advantage of this strategy is that it maximizes the signal index mismatch for a given

[symbol]

$$\vert \text{?} - \text{?} \vert . \\ \text{?} \text{indicates text missing or illegible when filed}$$

That is, in this strategy, the range of shunt mode effective index values is as far as possible from the effective index of signal mode (S) while still allowing the unwanted mode U to fall in the phase-matched region. The unwanted mode (U) to be suppressed must fall just within the range of effective index that would match with the effective index of shunt mode(s). The unwanted mode would thus be suppressed by phase matching with the shunt mode(s) only near the extreme of the variations. It should be noted that the same unwanted mode may have a phase matching condition with more than one shunt along the length of the fiber. One disadvantage of this strategy is that the most problematic unwanted mode may not be effectively phase matched to any of the shunt mode(s) and hence would not be suppressed in a “worst-case” scenario where variations are smaller than anticipated.

In an alternative embodiment, the variations in the fiber can take the form of an external perturbation included in the model for minimum index mismatch. More specifically, the minimum index mismatch between a signal mode and a shunt mode is approximately equal to an unperturbed index mismatch plus a perturbation, Δnₚₑᵣₜ. In an alternative embodiment, phase matching of the unwanted mode and shunt mode

[symbol]

$$( \text{?} )$$

$$\text{?} \text{indicates text missing or illegible when filed}$$

is achieved approximately for the unperturbed fiber. This implies that the minimum index mismatch between a signal mode and a shunt mode is approximately equal to the difference between the mode spacing between the lowest index signal mode (S) and the highest index unwanted mode (U) and a pre-determined index shift due to an applied perturbation (e.g. a bend). The condition for phase matching is expressed as—

[symbol]

$$\text{?} \vert \text{?} - \text{?} \vert \text{?} \vert \text{?} - \text{?} \vert \text{?} \vert \text{?} - \text{?} \vert \\ \text{?} \text{indicates text missing or illegible when filed} \qquad ( 3 )$$

For this condition to be effective, it is necessary that the highest index unwanted mode (U) fall near the center of the range of effective index values of a shunt mode including the variation. Accordingly, the highest index unwanted mode (U) would be effectively phase matched near the center of the expected length variation. This condition provides a sufficient margin in a “worst-case” scenario, since only slight variations are needed to suppress the most problematic mode. However, this embodiment has a potential disadvantage. Since the range of effective indices for effective phase matching is expanded due to inclusion of perturbation-induced index shifts, some signal modes, particularly those with lowest effective indices, may also satisfy phase matching condition.

As a consequence, those signal modes may experience excess loss by coupling some of the optical power to one or more of the shunt modes. This is not conducive to near single mode operation. Thus, there is a tradeoff between good worst-case suppression of an unwanted mode (e.g. achieved by Eq. 3) and good resistance of signal modes to unintentional coupling (e.g. achieved by Eq. 2). These considerations suggest that it is undesirable to place unperturbed shunt modes significantly closer in [symbol] effective index to the signal modes than to

[symbol]

$$\text{?} . \\ \text{?} \text{indicates text missing or illegible when filed}$$

That is, there is a desirable range of designs intermediate between Eqs. (2) and (3), and preferred designs will generally have a minimum signal mode index mismatch falling within the range defined by the end-points of Eqs. (2) and (3).

### Design Guidelines Using Step Index Model:

An alternative approach to formulating design guidelines is derived from a simple approximate model for determining effective index of guided modes in the core and shunt(s) using standard textbook solutions for a step index fiber (SIF). More specifically, an exemplary calculation using a scalar mode solver is described to calculate effective index for two circular step-index fibers, each having a core and a shunt in this example. For this exemplary calculation, the following parameters are assumed—operating wavelength is 1550 nm, n_{core}=1, and n_{clad}=0.98. Effective index is calculated as a function of normalized core size (the ratio of core diameter to wavelength) and the ratio (D_{core}/Dₛₕᵤₙₜ) where D_{core} and Dₛₕᵤₙₜ are core and shunt diameters, respectively. While these SIF parameters are selected for comparison with typical sizes of hollow cores currently used for commercial HCF, the exemplary selection of parameters should not be construed as limitations. The method may be easily adapted for other core and shunt size combinations as well.

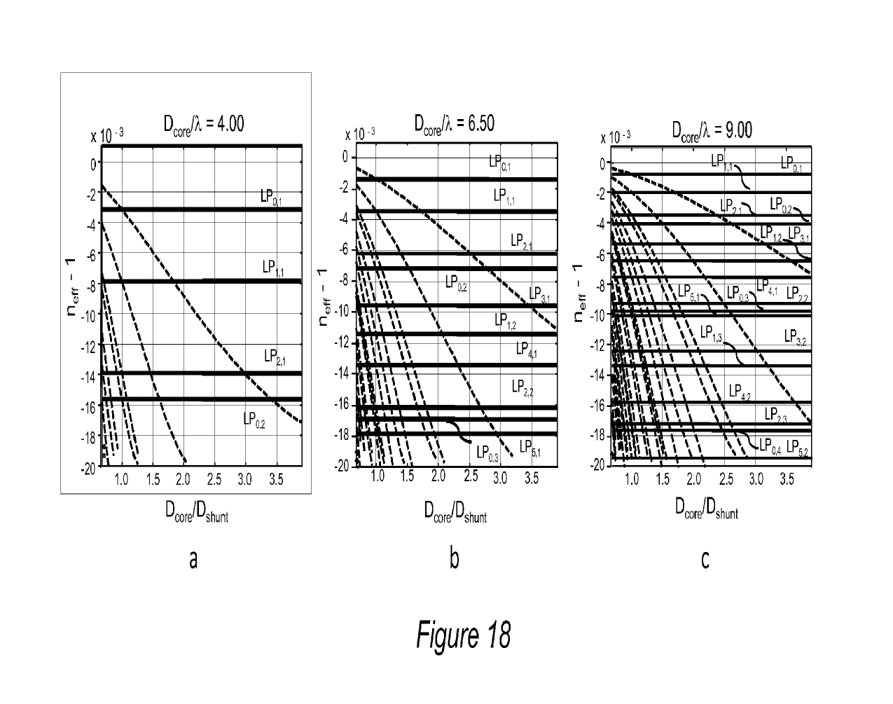

Effective index values for core and shunt modes calculated using the above SIF model are plotted in FIG. 18. More specifically, the three graphs a, b and c show effective index (y-axis) as a function of the ratio D_{core}/Dₛₕᵤₙₜ (x-axis). Three different core sizes normalized to 1550 nm wavelength, D_{core}/λ=4.0, D_{core}/λ=6.5 and D_{core}/λ=9.0, are used to illustrate the selective phase matching principle in graphs a, b and c, respectively, where the solid lines represent core modes (labeled individually) and the dashed lines represent shunt modes. Since the core diameter is fixed in each plot, the effective index of each core mode is a horizontal line (core modes are a function only of D_{core}, not of Dₛₕᵤₙₜ).

It is apparent that certain D_{core}/Dₛₕᵤₙₜ regimes are less suitable for selective phase matched coupling as compared to others. As an example, for D_{core}/Dₛₕᵤₙₜ˜1, almost all modes are nearly phase matched with one or more shunt modes, thus, such designs do not provide any selectivity. Accordingly, this range of D_{core}/Dₛₕᵤₙₜ is not suitable for unwanted mode suppression. For D_{core}/Dₛₕᵤₙₜ˜1.7-1.85, a phase-matched crossing between the fundamental shunt mode and LP_{1,1} core mode is present in each graph, thereby suggesting that the LP_{1,1} core mode would be effectively suppressed allowing for suitable single mode operation in the fundamental core mode. Shown in graph b, in addition to fundamental core mode, the region D_{core}/Dₛₕᵤₙₜ˜1.7—also shows crossings for other core modes namely, LP_{0,2} and LP_{2,1}, thereby implying that all three groups of related modes could be suppressed for D_{core}/Dₛₕᵤₙₜ˜2.0 provided some amount of variation, such as a bend or a twist, along the length of the fiber is present. While the ratio D_{core}/Dₛₕᵤₙₜ˜2.0 does not agree precisely with that of the detailed bandgap-fiber calculation (which is 5/3=1.67 for a 19-cell core and 7-cell shunt), it provides a quick, intuitive, and fairly accurate guideline.

For larger ratios of about D_{core}/Dₛₕᵤₙₜ˜2.2-2.7, the fundamental shunt mode is far from the LP_{1,1} and LP_{0,2} core modes. Such a design could also achieve selective phase-matching to LP_{L′}, LP_{0,2}, and LP_{2,1} core modes, albeit with a larger amount of added perturbations (e.g. Δnₚₑᵣₜ˜0.002 for D_{core}/λ=6.5). Larger ratios D_{core}/Dₛₕᵤₙₜ>2.7 may be more suitable in cases where LP_{0,1} and LP_{1,1} core modes are signal modes, for example, in a space-division multiplexed transmission. In this regime, LP_{0,2} and LP_{2,1}-like modes can be phase matched, as well as LP_{3,1} and LP_{1,2} if needed. Similarly, D_{core}/Dₛₕᵤₙₜ>4 may be suitable in cases where LP_{0,2} and LP_{2,1} core modes are also signal modes.

While these examples are described in view of the most desirable regime where for D_{core}/Dₛₕᵤₙₜ>1, graphs a, b and c in FIG. 18 suggest further possible operation around D_{core}/Dₛₕᵤₙₜ˜0.7-0.8, where the LP_{0,1} core mode has substantial index mismatch (for example 0.0005 in graph b) while the next four scalar modes are more nearly index matched. Operation in this regime would require fairly careful fiber handling: for example, an index mismatch of 0.0005 and core spacing ˜25 microns implies potential problems with robustness to perturbations (for example, bends of ˜10 cm diameter would cause very high signal loss).

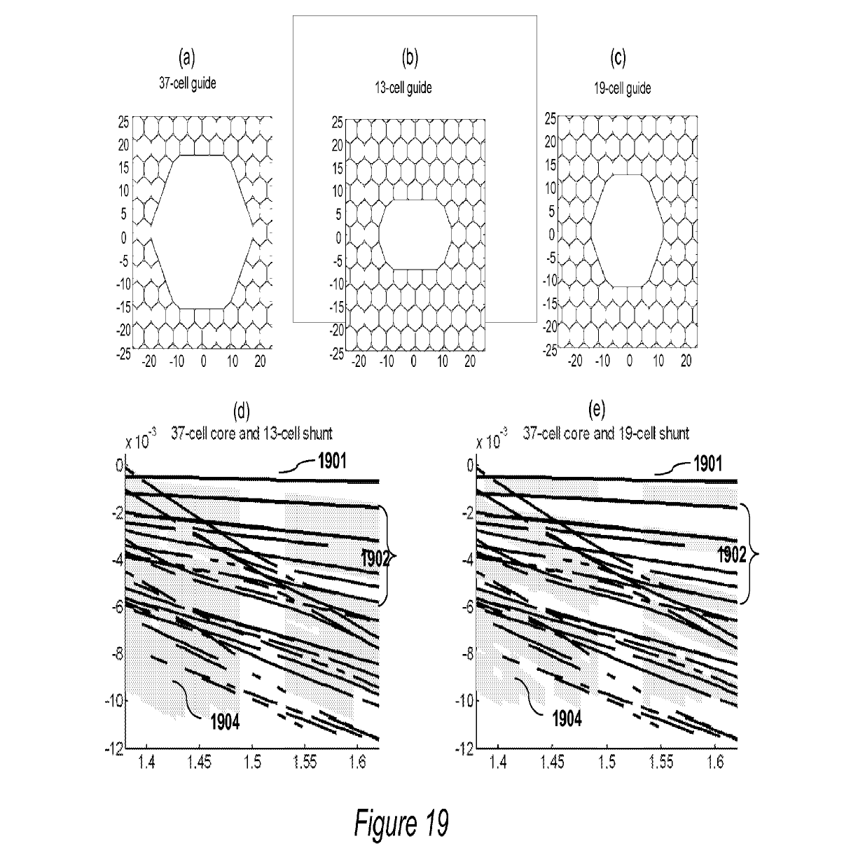

Referring back to earlier examples described in reference with FIGS. 6 and 7, specific combinations of core and shunt sizes, core-shunt spacing and specific perturbation induced effective index shifts were selected to introduce the concept of selective phase matching conditions for mode suppression. It is noted that nominal index mismatch is independent of core-shunt spacing, and perturbation induced index shift may be treated as an estimated additive factor. In one approach, phase matching conditions may also be estimated by calculating effective index for a core guiding region (with no shunt) and a shunt guiding region (with no core) independently for different size cores and comparing the effective indices by superimposing the results. Some exemplary structures shown in FIGS. 19a-c have been used to calculate effective index of core and shunt modes explain the concepts.

More specifically, FIG. 19a shows a 37-cell nearly circular core structure whereas FIGS. 19b and 19c show a 13-cell elliptical, and a 19-cell circular guiding structures, respectively. The latter structures may be suitable as a shunt in fibers designed according to embodiments of the present invention. Calculated effective index is plotted as a function of wavelength (in microns) for different modes of the 37-cell core (lines) and perturbed modes of a 13-cell shunt are superimposed as shaded regions using Δnₚₑᵣₜ=0.0008 in FIG. 19d, whereas results of similar calculations using a 19-cell shunt (shaded, using Δnₚₑᵣₜ=0.0004) superimposed with the 37-cell core are shown in FIG. 19e. Referring to FIG. 19d, the 37-cell core modes include a top solid trace 1901 (the fundamental mode) and many lower traces 1902 (higher order modes, a few of them collectively shown with a bracket) and the shaded area 1904 shown in both FIG. 19d and in FIG. 19e indicates the region of phase matching.

From FIG. 19d, it is clear that if the 13-cell core is used for a shunt, by adding some perturbation induced index shift, for example Δnₚₑᵣₜ˜0.0008, selective phase matching between the shunt modes and many of the unwanted modes 1902 (assuming only LP_{0,1} is a signal mode) can be achieved. It may be recalled that a pre-determined amount of perturbation induced shift in index mismatch may be introduced in the form of an additive effective index (Δnₚₑᵣₜ). Such perturbation induced shift may be introduced by bending the fiber in a pre-determined bend diameter.

Referring now to FIG. 19e, it is clear that if the 19-cell core is used as a shunt, the possibility of adding a perturbation induced shift in shunt mode index so as to phase-match the unwanted modes, but not phase match the signal mode, is much more constrained. With Δnₚₑᵣₜ=0.0004, one can extend the top shaded (phase-matched) region to include the LP_{1,1} mode at most wavelengths, but in this case the fundamental mode 1901 (top solid trace) is very nearly phase-matched as well (as shown by the top part of the shaded region 1904). This is because an unperturbed shunt mode has nearly the same index mismatch for both the LP_{1,1} and LP_{0,1} modes of the 37-cell core, making selective coupling difficult. Effective index mismatch due to perturbation of the same order needed to suppress the LP_{1,1} core mode may also lead to undesirable loss in the fundamental core mode. While this combination of core and shunt sizes may be useful with very precise control of variations, it is not as robust as other embodiments of the present invention.

The principles outlined above may be used to identify core and shunt size combinations useful for effective mode suppression leading to near single mode operation in the core. Table 1 below shows combinations of core and shunt designs that may be favorable for selectively suppressing unwanted higher order modes and achieving effective near single mode operation in the core, and summarizes important parameters extracted from simulated phase matching curves similar to those shown in FIG. 19d.

TABLE I

| | | Core | | | Shunt | effective | | |
|---|---|---|---|---|---|---|---|---|
| Core | | D_{eff}/L | Shunt | | D_{eff}/L | D_{core}/Dₛₕᵤₙₜ | n_{eff}^{U}-n_{eff}^{shunt} | n_{eff}^{S}-n_{eff}^{shunt} |
| 7-cell | [symbol] | 2.4 | 3-cell | [symbol] | 1.4 | 1.7 | 0.0003 | 0.0040 |
| 14-cell | [symbol] | NA | 4-cell | [symbol] | NA | NA | 0.0019 | 0.0038 |
| 19-cell | [symbol] | 4.2 | 3-cell | [symbol] | 1.4 | 3.0 | 0.0040 | 0.0055 |
| | | | 4-cell | [symbol] | NA | NA | 0.0023 | .0038 |
| | | | 6-cell | [symbol] | 2.0 | 2.1 | 0.0010 | 0.0027 |
| | | | 7-cell | [symbol] | 2.4 | 1.7 | 0.0000 | 0.0019 |
| | | | 10-cell | [symbol] | NA | NA | −0.001 | +0.001 |
| 29-cell | [symbol] | NA | 6-cell | [symbol] | 2.0 | NA | 0.0023 | 0.0032 |
| | | | 7-cell | [symbol] | 2.4 | NA | 0.0013 | 0.0022 |
| | | | 10-cell | [symbol] | NA | NA | 0.0004 | 0.0014 |
| 37-cell | [symbol] | 6.0 | 3-cell | [symbol] | 1.4 | 4.3 | 0.0052 | 0.0061 |
| | | | 6-cell | [symbol] | 2.0 | 3.0 | 0.0024 | 0.0033 |
| | | | 7-cell | [symbol] | 2.4 | 2.5 | 0.0015 | 0.0024 |
| | | | 10-cell | [symbol] | NA | NA | 0.0006 | 0.0015 |
| | | | 13-cell | [symbol] | NA | NA | 0.0004 | 0.0014 |

Table I: Additional core and shunt physical parameter combinations used for estimating selective phase matching conditions to suppress HOMs.

In particular, the first three columns pertain to different core size, shapes and, for circular cores an “effective diameter” normalized to the hole spacing D_{eff}/L. The effective diameter is so defined that a step-index fiber with diameter D_{eff} and index contrast n_{core}−n_{clad}=0.02 has similar effective index values for LP_{0,1} and LP_{0,2}-like modes. Particularly for cores having circular geometry, the effective diameter differs from the simple physical/geometrical width of the guiding region. The next three columns represent shunt properties, specifically, the shunt size, shape, and, for circular cross section shunt, an effective shunt diameter, normalized to spacing between holes. Relative sizes of the core and shunt is expressed in terms of their effective diameters and is listed in column seven.

The next column n_{eff}^{U}−n_{eff}^{shunt} indicates the approximate nominal index mismatch for the first higher-order core mode, suggesting the amount of dilation and/or variation needed to achieve phase-matching between shunt and the LP_{1,1}-like “U” mode. The last column n_{eff}^{S}-n_{eff}^{shunt} indicates the approximate nominal index mismatch of the fundamental core mode, suggesting the amount of dilation and/or variation that would cause undesirable phase-matching between a shunt mode and the LP_{0,1}-like “S” mode. These two columns help identify the degree of variation (e.g. bend perturbation) compatible with these cores, and also whether dilations are beneficial. Dilation in this context refers to intentional expansion of the core by a small predetermined amount over a nominal core size.

As mentioned previously, dilation may be introduced at the time of manufacturing by applying pressure or compression while drawing the fiber in a stack-and-draw method. In cases where n_{eff}^{U}−n_{eff}^{shunt} is negative, a dilation of the core (larger core→larger n_{eff}^{U}) or shunt (smaller shunt smaller n_{eff}^{shunt}), would be desirable so that the nominal index mismatch is close to zero or, alternately, positive. This helps achieve the constraints that variations achieve namely, selective phase matching of LP_{1,1}—type unwanted modes, while not causing unwanted phase matching to the fundamental mode.

Similar dilation may also be used for the fiber designs shown in FIGS. 19a-c. The values are only illustrative, and will vary depending on the detailed core web geometry (including any anti-resonant features), hole-spacing, air-fill fraction, etc. Other combinations are equally effective in designing HCF and may occur to those skilled in the art without digressing from the principles of invention. The table is particularly useful in better mapping results from a statistical approach for designing a HCF in accordance with embodiments of the present invention.

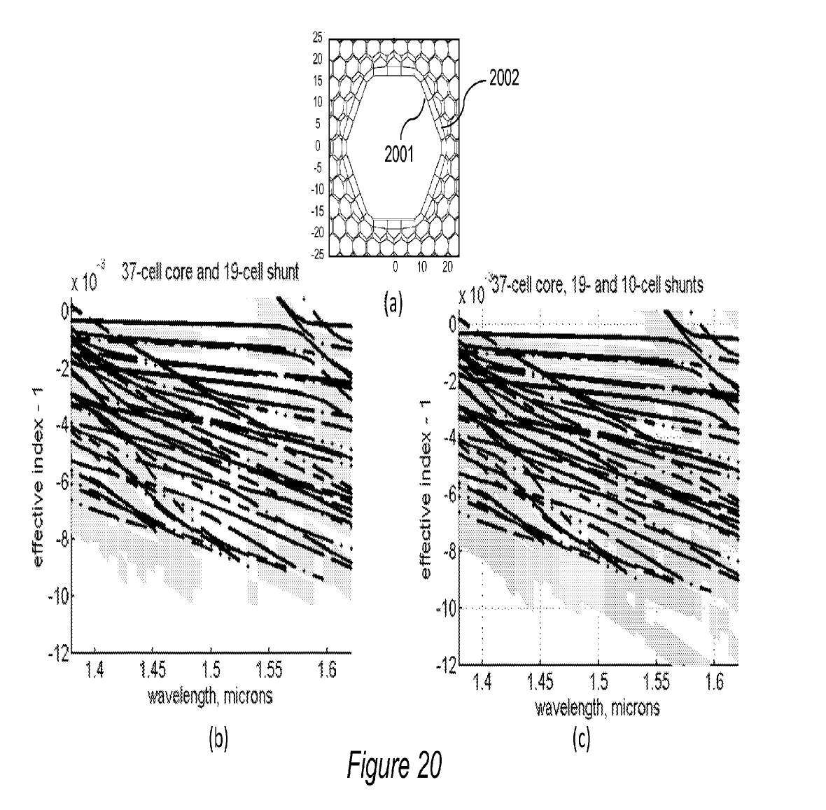

An example of using dilation to achieve desirable phase matching is demonstrated in FIGS. 20a-c. More specifically, an inventive fiber having a modified core geometry (shown as 2002) in FIG. 20a has roughly a 10% increase in core diameter relative to the geometry shown in FIG. 19a (shown as 2001 for comparison). The concepts may be better understood by a comparison of results plotted in FIGS. 19e and 20b. Results obtained from effective index calculation using a 37-cell dilated core and a 19-cell shunt are shown in FIG. 20B. In particular, modes of a dilated 37-cell core (with the 10% increase relative to its default topological size) are shown as solid lines while modes of the perturbed (undilated) 19-cell shunt are shown as light shaded regions (assuming Δnₚₑᵣₜ=0.0004). For this exemplary fiber, LP_{1,1} core modes and LP_{0,1} shunt modes exhibit phase matching with a modest degree of variation, while fundamental core modes have a much larger index mismatch.

Earlier examples of inventive fibers shown in FIGS. 7, 8, 10 and 12 have two symmetrically placed shunts of similar size. However, it need not be so in all cases. Principles of the inventive fibers described earlier may also be applied to different numbers of cores or shunts, to non-symmetrical arrangements of shunts, and to designs with non-identical shunts. In particular, intentionally different shunts can be useful when many different modes need to be suppressed, or where greater robustness is needed. In an exemplary embodiment, an inventive fiber is configured using a 37-cell core and two shunts, a 10-cell (elliptical) and a 19-cell (circular), respectively. Effective index calculated for such a structure is shown in 20c.

In this exemplary embodiment, multiple distinct shunt sizes are used to provide complimentary phase-matching coverage of unwanted modes. The effective index graph shown in FIG. 20c is substantially similar to the one shown in FIG. 20b, representing modes of the dilated 37-cell core and the perturbed, un-dilated 19-cell shunt (shaded), but further adds modes of a perturbed 10-cell shunt (additional shaded regions), where Δnₚₑᵣₜ=0.0004 was used for both sets of shunt modes. The two different shunt sizes are complimentary in covering different ranges of effective index. For example, the 19-cell shunt provides good phase matching to the LP_{1,1} core modes, while the 10-cell shunt provides phase-matching to LP_{0,2} and LP_{2,1} core modes. Together, they provide sufficient suppression of different unwanted modes resulting in near single mode operation.

### Other Design Considerations:

The selectivity of suppression of unwanted modes is facilitated by resonantly coupling unwanted modes to one or more shunt modes. However, suppression of an unwanted mode still requires a loss mechanism. The loss mechanism may include, but is not limited to, tunneling to the edge of the inner cladding, and/or arranging a shunt proximal to the edge of the photonic band gap microstructure cladding (as in FIG. 8A). Alternatively, loss may be due to scattering, absorption, mode coupling, etc. or a combination of mechanisms. The loss mechanism may be engineered for example, by additional fabrication steps including surface roughness or absorbing materials, etc., that are well known in the art. Small shunts, especially those with size less than 7-cells tend to have very high surface-scattering loss, which may be advantageous in achieving sufficient loss in any modes coupled to them.

The symmetry and the local geometry about each guiding region and also the symmetry of the overall fiber structure have important impact on fabrication robustness, birefringence, etc. Generally, more symmetric geometries are preferred, except in applications where birefringence is required. Similarly, core and shunt boundaries that are more convex, compact, and approximately circular generally lead to greater fabrication ease, and are preferred in fiber design. Exemplary fibers are constructed with a one-cell separation between core and each shunt (as shown in FIGS. 6A, 7A, and 8A) and also with a two-cell separation between core and each shunt. Suppression of higher order modes is extremely good for one-cell separation, and moderate for two-cell separation.

Based on these measurements, the optimum separation is expected to fall within the range 1-3 cells. It is expected that coupling strength would exponentially decrease with this separation. Therefore, separations of 4 cells or greater are expected to show poor suppression of unwanted modes, high sensitivity to fabrication and variations (e.g. bend orientation), etc. There is a tendency for structures with very small separation to have distortion of the ideal geometry due to difficulties of fabrication. Thus, fibers with 1-cell separation or less have an important fabrication disadvantage. The prescribed separation range of 1-3 cells represents a compromise in the tradeoff between coupling strength and fabrication ease.

### Arranging for Desired Variations and Perturbation:

It was demonstrated earlier that variations along the length of the fiber play an important role in suppressing unwanted modes. Some variations may be intrinsic to the fiber, for example, from intentionally changing pressure while drawing the fiber which can lead to non-uniformity in core and/or shunt diameter (size) over nominal values, dilation, variation in interface contours, surface roughness, etc. Variations intrinsic to the fiber have certain advantages, such as, being insensitive to cabling, packaging and fiber arrangement. In another aspect, variations may be external to the fiber in form of bends, twists, or other physical arrangements, exemplifying a perturbation not intrinsic to the fiber, but which may be intrinsic to the cable containing such a fiber.

Although, the principles of the invention and in particular, the role of perturbation in facilitating selective resonant coupling, are illustrated using simple examples of dilating the core or by introducing a pre-determined bend to compensate for the effective index mismatch, other kinds of variations that introduce perturbations causing effective index mismatch may include fiber design parameters, fiber manufacturing aspects, cables, methods of making fiber cables, fiber layout, fiber packaging, etc. Applying such variations in suitable combinations and sub-combinations are equally pertinent. One important aspect of this invention is that the variations are treated statistically whether introduced unintentionally or intentionally.

Constraints on variations are quite different depending on the application of the inventive fiber. For example, some applications require that the entire fiber fit into a compact package (e.g. D_{bend}=2-20 cm), and allow the curvature to be fairly well defined or controlled in the manufacture of a device (e.g. sensor). Other applications involve a cabled fiber extending over long distances, where the shape of the fiber tends to be quasi-helical, less precisely controlled, including randomly varying curvature, D_{bend}>˜10 cm, and often subject to significant unavoidable perturbations. In another application, a fiber may be arranged in an approximately helical shape, such that the transverse position of the center of the fiber's core is expressed by a mathematical expression, such as—

[x,y]=[Rₕ cos(φ₀+2πz/Λₕ),Rₕ sin(φ₀+2πz/Λₕ)] (4)
and the radius of curvature is expressed as—

R_{curv}=(Rₕ²+(Λₕ/2π)²)/|Rₕ| (5)

For example, using methods known in the art, a fiber cable may be so constructed that the fiber typically has a controlled helical radius Rₕ in the range of 1-5 mm. More specifically, a radius of curvature of R_{curv}˜2 cm, R_{curv}˜6 cm or R_{curv}˜21 cm may be generated for a helical period Λₕ=5 cm, Λₕ=10 cm, or Λₕ=20 cm, respectively, that are quite typically encountered while cabling a fiber. However, small R_{curv} achieved either using a large Rₕ or small Λₕ may have undesirable consequences in terms of bend loss, cable size, stiffness, total propagation length etc. In one embodiment, a helical arrangement may have a helix radius of approximately 2 mm along with a helical period in the range 30-90 mm, resulting in a radius of curvature in the range 1.3-10 cm. In another embodiment, a helical arrangement may have a helix radius of approximately 3 mm along with a helical period in the range 40-110 mm, resulting in a radius of curvature in the range 2-10 cm. In yet another embodiment, a helical arrangement may have a helix radius of approximately 5 mm along with a helical period in the range 70-140 mm, resulting in a radius of curvature in the range 3-10 cm. A helical arrangement may be determined by cable elements including tubes surrounding the fiber and/or filaments that the fiber wraps around. It is understood that the fiber arrangement will not form a perfect helix, but that the helix radius and period are still useful characterizations of the fiber shape.

Helical arrangements of fibers or cores within fibers are known in the art. It is important to understand that while incorporating any kind of variation for selective phase matching of unwanted core modes to one or more shunt modes, variations either alone or in any combination or sub-combinations, must satisfy following basic requirements:
a) a variation must be large enough to provide phase matching to as many unwanted modes as possible;
b) a variation must be large enough to reduce fabrication sensitivity;
c) a variation must be compatible with practical limits on perturbations (curvature in real cabling, etc.); and
d) a variation must not introduce impairments including loss of signal modes, fiber damage due to excessive bending, etc.

Thus, using methods well known in the art, one could select parameters of a coil or cable to satisfy the above requirements. For example if phase matching considerations require Δn_{pert,min}<Δnₚₑᵣₜ<Δn_{pert,max}, and if Δnₚₑᵣₜ=aₛₑₚ/R_{curv} then one could readily define appropriate values for core-shunt separation, and for helix period and helix radius of a cable arrangement that provide the desired perturbations.

The examples and embodiments described here merely illustrate broad principles of the invention. A wide variety of HCF may be constructed by applying the principles illustrated in different embodiments that may be implemented alone or in various combinations and sub-combinations, depending upon applications. All such combinations and sub-combinations are within the purview of the basic principles and are broadly captured in the following claims.

What is claimed is:

1. An optical fiber comprising:
a photonic band gap cladding region including an array of lattice holes, said cladding region further comprising:
a first hollow guiding region, configured as a core to support a signal mode and at least one unwanted mode, and
a second hollow guiding region configured to support a plurality of modes as shunt modes, wherein an effective index difference between the at least one unwanted mode and at least one shunt mode is smaller than an effective index difference between the signal mode and any of the plurality of shunt modes, such that selective coupling of the at least one unwanted mode to the at least one shunt mode is preferred over coupling of the signal mode to any of the plurality of shunt modes,
wherein a substantial index-mismatch exists between the signal mode and any of the plurality of shunt modes at substantially all positions along the fiber, such that coupling of the signal mode over the total length of fiber is small.

2. The optical fiber of claim 1, wherein the coupling of the at least one unwanted mode to the at least one shunt mode suppresses transmission of said unwanted mode.

3. The optical fiber of claim 1, wherein the signal mode is transmitted as a fundamental core mode, and wherein said coupling allows for the optical fiber to function as a single-mode fiber.

4. The optical fiber of claim 3, wherein there is an additional unwanted mode, and said additional unwanted mode experiences high loss due to surface modes of the optical fiber.

5. The optical fiber of claim 1, wherein said selective coupling of the at least one unwanted mode and the at least one shunt mode occurs through a phase matching condition, and wherein an associated coupling rate decreases with an increase in effective index difference.

6. The optical fiber of claim 1, wherein at least one of a core or a shunt diameter varies about a respective nominal diameter along the length of the optical fiber, thereby generating variations in effective index difference between the at least one unwanted mode and the at least one shunt mode along the length of the optical fiber.

7. The optical fiber of claim 1, wherein variations in effective index difference between the unwanted mode and the at least one shunt mode are generated by applying an external perturbation.

8. The optical fiber of claim 7, wherein said external perturbation is one of a bend, a twist, a semi helix, or a combination thereof to the optical fiber, providing a varying additive effective index shift along the length of the optical fiber.

9. The optical fiber of claim 1, wherein an external perturbation may be applied so as to provide a range of effective indices around the effective index of the at least one shunt mode where phase matching is achieved, thereby facilitating selective coupling of the signal mode and additional core modes falling in a range of effective index along the length of the fiber.

10. The optical fiber of claim 1, wherein a nominal diameter of the first hollow guiding region is substantially larger than a nominal diameter of the second hollow guiding region.

11. The optical fiber of claim 8, wherein a combination of a diameter and spacing of lattice holes, core, and shunt, and their relative placement in the cladding region generate a nominal effective index difference between the at least one unwanted mode and the at least one shunt mode, such that the nominal effective index difference and effective index shift substantially cancel at some positions along the fiber to facilitate coupling, and such that the nominal effective index difference is sufficiently small to permit this cancellation.

12. The optical fiber of in claim 1 further including at least one additional shunt.

13. The optical fiber of claim 12, wherein said additional shunt is substantially similar to the second hollow guiding region, and wherein the second hollow guiding region and the additional shunt are placed symmetrically or asymmetrically around the core.

14. The optical fiber of claim 12, wherein said additional shunt is dissimilar to the second hollow guiding region, and wherein the second hollow guiding region and the additional shunt may be placed symmetrically or asymmetrically around the core,

15. The optical fiber of claim 14, such that more than one unwanted mode are selectively suppressed.

16. The optical fiber of claim 1, further comprising one or more higher order modes that may be transmitted as signal modes.

17. The optical fiber of claim 10, wherein the nominal diameter of the first hollow guiding region is around 1.7-2.7 times the nominal diameter of the second hollow guiding region

18. An optical fiber comprising:
a photonic band gap cladding region including an array of lattice holes, said cladding region further comprising:
a first hollow guiding region, configured as a core to support a signal mode and at least one unwanted mode,
a second hollow guiding region configured to support at least one mode as a shunt mode, and
a variation along a length of the optical fiber, wherein the variation provides resonant matched coupling of the at least one unwanted mode to the shunt mode at some positions along the fiber.

19. The optical fiber of claim 18, wherein resonant coupling is not achieved between the signal mode and the shunt mode.

20. The optical fiber of claim 18, wherein the fiber, in the absence of the variation, does not provide resonant coupling between the unwanted mode and the shunt mode.

21. An optical fiber comprising:
a cladding region comprising a photonic band gap material, said cladding region further comprising:
a first hollow guiding region configured to support a signal mode and at least one unwanted mode,
a second hollow guiding region configured to have at least one shunt mode, and
said fiber further configured with an external perturbation varying along the length of the fiber, such that the at least one unwanted mode selectively couples to the at least one shunt mode over a length of the optical fiber.

22. The optical fiber of claim 21, wherein said perturbation provides an additive effective index shift, wherein this shift provides that the at least one unwanted mode and the at least one shunt mode have substantially the same effective index at some positions along the fiber length.

23. The optical fiber of claim 22, whereby the at least one unwanted mode and the at least one shunt mode have substantially different effective index values at other positions along the fiber length, such that coupling between the at least one unwanted mode and the at least one shunt mode is not effective at these positions.

24. The optical fiber of claim 22, whereby the signal mode and the at least one shunt mode have substantially different effective index values at all or nearly all positions along the fiber length, such that coupling between signal and shunt modes is not effective over the total fiber length.

25. The optical fiber of claim 21, wherein said perturbations are provided by arranging the fiber in an approximately helical arrangement.

26. The optical fiber of claim 25, wherein the helical arrangement is characterized by a helical period in the range 30-140 mm.

27. The optical fiber of claim 25, wherein the helical arrangement is characterized by a helix radius in the range 2-5 mm.

28. The optical fiber of claim 25, wherein the helical arrangement is determined by cable elements, which may include tubes surrounding the fiber and/or filaments that the fiber wraps around.

29. The optical fiber of claim 21, wherein the helical arrangement is characterized by helix radius of approximately 3 mm along with a helical period in the range 40-110 mm.

30. The optical fiber of claim 21, wherein the helical arrangement is characterized by helix radius of approximately 2 mm along with a helical period in the range 30-90 mm.

31. The optical fiber of claim 21, wherein the helical arrangement is characterized by helix radius of approximately 5 mm along with a helical period in the range 70-140 mm.

32. The optical fiber of claim 2, wherein said suppression is accomplished by proximity of the shunt to the edge of the array of lattice holes.

33. The optical fiber of claim 2, wherein said suppression is accomplished by introducing surface roughness, scattering, absorptive materials, mode coupling features, or a combination of features to increase shunt mode loss.
